(19) United States
(12) Patent Application Publication
(10) Pub. No.: US 2024/0211972 A1
(43) Pub. Date: Jun. 27, 2024

(54) METHOD OF PROVIDING A RESIDENTIAL NET LEASE NETWORK WITH A 1031 EXCHANGE DATABASE

(71) Applicant: Capview Partners, LLC, Dallas, TX (US)

(72) Inventors: John Hammill, Dallas, TX (US); Kevin Connelly, Dallas, TX (US); Danilo da Silva, Dallas, TX (US)

(21) Appl. No.: 18/393,298

(22) Filed: Dec. 21, 2023

Related U.S. Application Data
(60) Provisional application No. 63/435,475, filed on Dec. 27, 2022.

(51) Int. Cl. G06Q 30/0201; G06Q 30/0645; G06Q 50/163

(52) U.S. Cl. CPC G06Q 30/0201; G06Q 30/0645; G06Q 50/163

(57) ABSTRACT

Implementations claimed and described herein provide systems and methods for processing 1031 exchanges of real properties through a network, with a focus on providing residential net leases as a part of the exchange. In some implementations, identifying properties that fall within net lease parameters and determining, based on an initial exchange amount, one or more bundles of properties of the identified replacement properties that have a total exchange amount is considered to be within a threshold amount of the initial exchange amount. In some implementations, recording an accounting for an amount remunerated to the investors based on determined profit margins over term of lease and the net lease terms, and sending an instruction to trigger a transfer to the single reserve fund.

### CROSS-REFERENCE TO RELATED APPLICATIONS

This application claims priority from U.S. provisional application 63/435,475 filed Dec. 27, 2022, the disclosure of which is incorporated herein by reference.

### FIELD OF THE DISCLOSURE

The present disclosure is generally related to creating and managing residential net leases between owners of the rental property and the property renters with a 1031 exchange component.

### BACKGROUND

Selling investment properties and using the proceeds to purchase single-family rental properties that qualify for a deferred capital gain under Section 1031 of the Internal Revenue Code of 1986, as amended (“1031 exchange”), is a difficult and confusing process for real estate investors. In addition, it is a challenge to find properties that the investor would be interested in purchasing or swapping that satisfy the numerous requirements to defer the capital gain on the original property due to the tight time constraints needed to satisfy the requirements. Also, the process involved with swapping properties can lead to the investors spending a significant amount of time trying to ensure all the requirements are met, and all the rules are properly followed. Lastly, the complexity of complying with these requirements becomes more complicated the larger the transaction.

### SUMMARY

Disclosed are systems, apparatuses, methods, computer readable medium, and circuits for automating a residential net lease management tool with a 1031 exchange module. According to at least one example, a method includes receiving, over an expense network, an initial exchange amount over a communication network at a net lease management server configured to communicate with at least one third-party application. In some cases, the method includes receiving, over the expense network, market data associated with one or more regions sent over the communication network at the net lease management server. In some cases, the method includes initiating, by a net lease module, a reserve module and generating, by the reserve module, net lease parameters for the one or more regions based on a calculated profitability evaluation based on the market data received via the expense network, wherein the calculated profitability evaluation determines a threshold margin based on a percentage of an average rental rate and average fixed costs in the one or more regions.

In some cases, the method includes initiating, by the net lease module, an owner module and identifying, by the owner module, replacement properties that fall within the net lease parameters generated by the reserve module. In some cases, the method includes initiating, by the net lease module, a 1031 exchange module and determining, by the 1031 exchange module and based on the initial exchange amount, one or more bundles of the replacement properties of the identified replacement properties that have a total exchange amount is considered to be within a threshold amount of the initial exchange amount.

In some cases, the method includes initiating, by the net lease module, a manage module, and generating, by the reserve module, a set of net lease terms associated with the at least one of the replacement properties identified by the net lease module, based on inputs including fixed costs and variable costs determined the manage module, wherein weights are assigned to each input. In some cases, the method includes storing, by the net lease module in a lease database, the net lease terms and recording, by an accounting module in a reserve database associated with a single reserve fund, a first accounting for a first amount funded by one or more investors that are not respective owners of the respective properties. In some cases, the method includes recording, by the accounting module in the reserve database associated with the single reserve fund, a second accounting for a second amount remunerated to the investors based on determined profit margins over term of lease and the net lease terms stored at the lease database and sending, based upon the accountings of the reserve database over the communication network, an instruction to trigger a transfer to the single reserve fund.

In another example, a system for automating a residential net lease management tool with a 1031 exchange module is provided that includes a storage (e.g., a memory configured to store data, such as virtual content data, one or more images, etc.) and one or more processors (e.g., implemented in circuitry) coupled to the memory and configured to execute instructions and, in conjunction with various components (e.g., a network interface, a display, an output device, etc.), cause the system to receive, over an expense network, an initial exchange amount over a communication network at a net lease management server configured to communicate with at least one third-party application. In some cases the instructions cause the system to receive, over the expense network, market data associated with one or more regions sent over the communication network at the net lease management server and generate, by the reserve module, net lease parameters for the one or more regions based on a calculated profitability evaluation based on the market data received via the expense network, wherein the calculated profitability evaluation determines a threshold margin based on a percentage of an average rental rate and average fixed costs in the one or more regions.

In some cases, the instructions cause the system to identify, by the owner module, replacement properties that fall within the net lease parameters generated by the reserve module and determine, by the 1031 exchange module and based on the initial exchange amount, one or more bundles of the replacement properties of the identified replacement properties that have a total exchange amount is considered to be within a threshold amount of the initial exchange amount. In some cases, the instructions cause the system to generate, by the reserve module, a set of net lease terms associated with the at least one of the properties identified by the net lease module, based on inputs including fixed costs and variable costs determined the manage module, wherein weights are assigned to each input, and store, by the net lease module in a lease database, the net lease terms.

In some cases, the instructions cause the system to record, by the accounting module in a reserve database associated with a single reserve fund, a first accounting for a first amount funded by one or more investors that are not respective owners of the respective properties, record, by the accounting module in the reserve database associated with the single reserve fund, a second accounting for a second amount remunerated to the investors based on determined profit margins over term of lease and the net lease terms stored at the lease database, and send, based upon the accountings of the reserve database over the communication network, an instruction to trigger a transfer to the single reserve fund.

### BRIEF DESCRIPTION OF THE SEVERAL VIEWS OF THE DRAWINGS

Aspects of the present disclosure will be described more fully hereinafter with reference to the accompanying drawings in which like numerals represent like elements throughout the several figures, and in which example aspects of this disclosure are shown. Aspects of the claims may, however, be embodied in many different forms and should not be construed as limited to the aspects as set forth herein. The examples set forth herein are non-limiting examples and are merely examples among other possible examples.

FIG. 1 illustrates a method of providing a residential net lease network with accessibility to 1031 exchange databases.

FIG. 2 illustrates an example method performed by a net lease module.

FIG. 3 illustrates an example method performed by a reserve module.

FIG. 4 illustrates an example method performed by an owner module.

FIG. 5 illustrates an example method performed by an investor module.

FIG. 6 illustrates an example method performed by a manage module.

FIG. 7 illustrates an example method performed by an accounting module.

FIG. 8 illustrates an example method performed by a 1031 module.

FIG. 9 illustrates an example method performed by an exchange module.

FIG. 10 illustrates an example method performed by a selection module.

FIG. 11 illustrates an example method performed by an escrow module.

FIG. 12 illustrates an example method performed by a purchase module.

FIG. 13 shows an example system for implementing certain aspects of the present invention.

### DETAILED DESCRIPTION

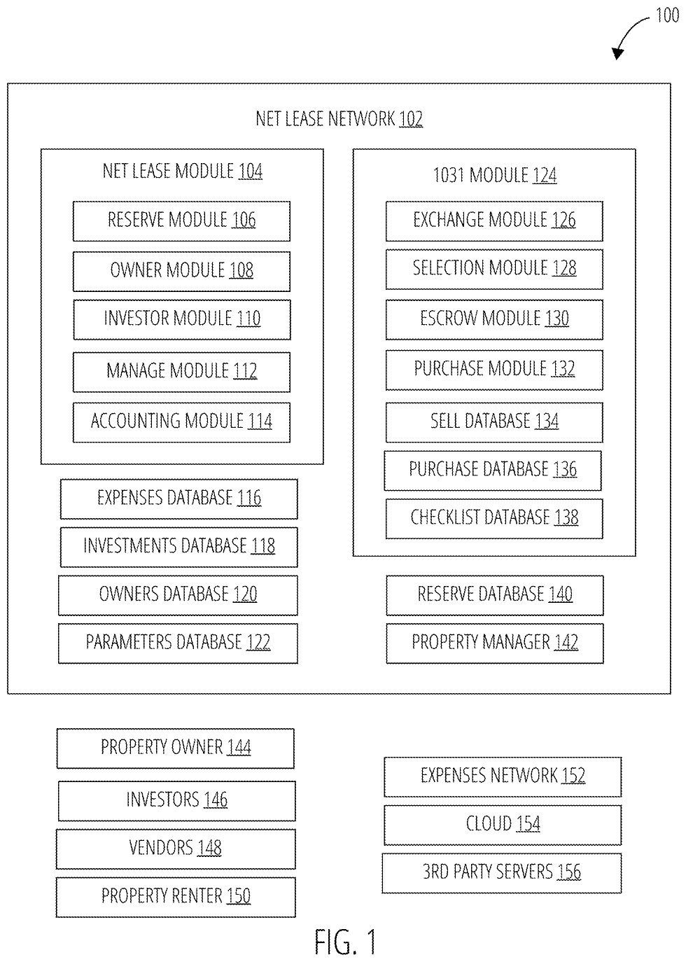

FIG. 1 illustrates a method of providing a residential net lease network with accessibility to 1031 exchange databases.

The present invention relates to a system and method for processing 1031 exchanges of real properties through a network, with a focus on providing residential net leases as a part of the exchange. By providing a pool of identified replacement properties ready for exchange, this system simplifies the exchange process, saves time, and ensures a more successful outcome. For example, the net lease network 102 may use advanced algorithms, such as linear programming or machine learning models, to identify optimal property combinations that meet exchange criteria. Furthermore, the net lease network 102 may handle complex constraints, such as nonlinear debt and equity structures, and ensure adherence to 1031 exchange rules. In some cases, the net lease network 102 may handle equity structures, including partnership agreements, for amounts remunerated to various parties, and provide the generation or completion of documents that may be used for transferring ownership stakes among investors.

This method comprises a net lease system 100 including a net lease network 102, which may be a software system or process to calculate a long-term net lease amount accounted for as a payment amount to property owners 128 of residential rental properties for a 15 to 30-year primary term and provides landlords with more net operating income for the first five to nine years in exchange for an up-front initial lease reserve fee that in combination with rents received from renters, allows the lessee to absorb all property level expenses and meet the agreed terms of the lease and make all net lease amounts.

The absolute net lease means that the lessee pays the landlord (lessor) a fixed lease payment with annual escalations according to a lease payment schedule in exchange for full control and uninterrupted rights to the property as if it were owned by the lessee for the period of the primary lease term and any renewal options it executes. These rights include the right to rent the property to sub-tenants/renters to generate rental income. The lessee is responsible for all property-level expenses including, but not limited to, taxes, insurance, maintenance, utilities, capital expenditures, replacement and repair of furniture, fixtures, and equipment (FF&E) and real property, management, etc.

Further, aspects of this disclosure may include a net lease module 104, which begins by connecting to the expenses network 152. The net lease module 104 receives the data from the expenses network 152. The net lease module 104 stores the data from the expenses network 152 in the expenses database 116. The net lease module 104 initiates the reserve module 106. The net lease module 104 initiates the owner module 108. The net lease module 104 initiates the investor module 110. The net lease module 104 extracts the first owner from the owners database 120. The net lease module 104 connects to the investors 146. The net lease module 104 determines the fixed and variable costs for the property. The net lease module 104 then creates the net lease terms for the property owner.

The net lease module 104 determines if the property owner 144 approved of the net lease terms. If it is determined that the property owner 144 approved of the net lease terms, the net lease module 104 assigns a property manager 142 to the property. The net lease module 104 stores the data in the investments database 118. If it is determined that the property owner 144 did not approve of the net lease terms or after the data is stored in the investments database 118 the net lease module 104 determines if there are any property owners 128 remaining in the owners database 120. If it is determined that more owners are remaining in the owners database 120, the net lease module 104 extracts the next owner from the owners database 120, and the process returns to connecting to the investors 146. If it is determined that there are no more owners remaining in the owners database 120, the net lease module 104 initiates the manage module 112. Then the net lease module 104 initiates the accounting module 114, and the process returns to connecting to the expenses network 152.

Further, aspects of this disclosure may include a reserve module 106, which begins by being initiated by the net lease module 104. The reserve module 106 extracts the first region from the expenses database 116. The reserve module 106 creates the region's net lease parameters. The reserve module 106 stores the parameters in the parameters database 122. The reserve module 106 determines if there are any more regions remaining in the expenses database 116. If it is determined that more regions remain in the expenses database 116, the reserve module 106 extracts the next region from the expenses database 116, and the process returns to creating the parameters for the net lease for the region. If it is determined that no more regions are remaining in the expenses database 116, the reserve module 106 returns to the net lease module 104.

Further, aspects of this disclosure may include an owner module 108, which begins by being initiated by the net lease module 104. The owner module 108 connects to the property owners 128. The owner module 108 identifies the potential property owners that may have a property that is within the parameters for a net lease. In some cases, generating net lease parameters for the specific region may be based on a calculated profitability evaluation that determines a threshold margin based on a percentage of an average rental rate based on square footage and average fixed costs in the specific region.

The owner module 108 sends a notification to the property owners 128 that have a property that fulfills the parameters for a net lease. The owner module 108 determines if the owner approves the notification. If the owner approves of the notification the owner module 108 receives the property details from the property owner 144. The owner module 108 stores the data in the owners database 120. If it is determined that the owner did not approve of the notification or after the data is stored in the owners database 120, the owner module 108 returns to the net lease module 104.

Further, aspects of this disclosure may include an investor module 110, initiated by the net lease module 104. The investor module 110 connects to the investors 146. The investor module 110 identifies potential investors for investment into the reserve database 140. The investor module 110 sends a notification to the investors 146. The investor module 110 receives the investment from the investors 146. The investor module 110 stores the received investment from the investors 146 in the reserve database 24. The investor module 110 returns to the net lease module 104.

Further, aspects of this disclosure may include a manage module 112, which begins by being initiated by the net lease module 104. The manage module 112 extracts the first data entry in the investments database 118. The manage module 112 determines the fixed and variable costs for the property. The manage module 112 pays the costs of the property. The manage module 112 collects rent from the renters 150. The manage module 112 stores the rent in the reserve database 140. The manage module 112 determines if there are more data entries remaining in the investments database 118. If it is determined that there are more data entries remaining in the investments database 118, the manage module 112 extracts the next data entry from the investments database 118. If it is determined that there are no more data entries remaining in the investments database 118, the manage module 112 returns to the net lease module 104.

Further, aspects of this disclosure may include an accounting module 114, initiated by the net lease module 104. The accounting module 114 determines the accounting for an amount remunerated to the property owners 128 determined based on the net lease terms. The accounting module 114 sends the accounting information to the property owners 128. The accounting module 114 determines the returns on investment of the residential investments. The accounting module 114 sends the accounting for the returns on investment of the residential investments to the investors 146. The accounting module 114 returns to the net lease module 104.

Further, aspects of this disclosure may include an expenses database 116, which contains the location of where the market data may be for the starting market rent, the market growth rate, the inflation rate, the vacancy rate, the rent collectability rate, the home price appreciation, the operating expenses which are stored as a data file and may contain the local taxes, including property taxes and fees, the insurance rates, the management fees, the maintenance budget, the homeowners association fees, the cost of utilities, and the asset management fees. In some aspects, the market data may be for a specific location or region or may be specific to a certain property location. In some aspects, each of the data points stored in the database may be used as an input into an algorithm to determine the net lease terms for the property owner 144, determine the rent for the specific property, and determine the profits or return on investment for the investors 146. In some aspects, the starting market price may be the cost per square footage, the average cost of rent in a certain location, the average cost of rent in a certain location based on the number of bedrooms, the average cost of rent in a certain region of a city or town, etc. In some aspects, the net lease module 104 may send a request to the expenses network 152 to receive relevant data points for a specific property location, for example, by using the mailing address.

As an example expenses database shown below, the database may contain the location of where the market data is for, the starting market rent, the market growth rate, the inflation rate, the vacancy rate, the rent collectability rate, the home price appreciation, and the operating expenses, which are stored as a data file and may contain the local taxes, the insurance rates, the management fees, the maintenance budget, the homeowners association fees, the cost of utilities, and the asset management fees. In some aspects, the market data may be for a specific location or region or may be specific to a certain property location. In some aspects, each of the data points stored in the database may be used as an input into an algorithm to determine the net lease terms for the property owner 128, determine the rent for the specific property, and determine the profits or return on investment for the investors 146. In some aspects, the starting market price may be the cost per square footage, the average cost of rent in a certain location, the average cost of rent in a certain location based on the number of bedrooms, the average cost of rent in a certain region of a city or town, etc. In some aspects, the net lease module 104 may send a request to the expenses network 152 to receive relevant data points for a specific property location, for example, by using the mailing address.

| | Starting | Growth | | Vacancy | Rent | Home Price | Operating |
|---|---|---|---|---|---|---|---|
| Location | Market Rent | Rate | Inflation | Rate | Collectability | Appreciation | Expenses |
| Boston, MA | $4.60/sq. ft. | 5% | 2.20% | 0.47% | 95% | 8.11% | BostonOE.Data |
| New York, NY | $9.00/sq. ft. | 10% | 2.20% | 1.20% | 92% | 17% | NewYorkOE.Data |
| Los Angeles, CA | $7.00/sq. ft. | 8% | 2.20% | 3% | 91% | 10% | LosAngeles.Data |

### Example Expenses Database

Further, aspects of this disclosure may include an investments database 118, which contains a property owner ID, the property ID, the length of the lease or the years remaining on the net lease, the accounting for the lease amount remunerated to the property owner 144, the annual increase of the accounting for the net lease amount remunerated to the property owner 144, the fixed costs per month for the property, the rent collected per month for the property, and the monthly profits for the property. In some aspects, a property owner 144 may have multiple properties under a net lease with the net lease network 102. In some aspects, the fixed and variable costs may be different for each property, or if there are multiple properties located within a certain radius, there may be one vendor 132 and/or one property manager 142 for each of the properties to lower the monthly fixed and variable costs. In some aspects, the database may be shown as monthly, quarterly, or annual payments, expenses, profits, etc. In some aspects, the investors 146 may receive a percentage of the monthly profits or may be paid out based on quarterly or annual profits.

As shown in an example investments database shown below, the investments database may contain a property owner ID, the property ID, the length of the lease or the years remaining on the net lease, the lease payment to the property owner 128, the annual increase of the net lease payment to the property owner, the fixed and variable costs per month for the property, the rent collected per month for the property, and the monthly profits for the property. In some aspects, a property owner 128 may have multiple properties under a net lease with the net lease network 102. In some aspects, the fixed and variable costs may differ for each property, or if there are multiple properties located within a certain radius, there may be one vendor 132 and/or one property manager 126 for each of the properties to lower the monthly fixed and variable costs. In some aspects, the database may be shown as monthly, quarterly, or annual payments, expenses, profits, etc. In some aspects, the investors 146 may receive a percentage of the monthly profits or may be paid out based on quarterly or annual profits.

| Property | | Lease | | Lease Payment | | | Monthly |
|---|---|---|---|---|---|---|---|
| Owner ID | Property ID | length | Lease Payment | Increase | Fixed Costs | Rent Collected | Profits |
| JS123 | JS123-001 | 15 years | $2,000/month | 1% | $100/month | $2,500/month | $400 |
| JS123 | JS123-002 | 14 years | $2,200/month | 1% | $110/month | $2,700/month | $390 |
| JS123 | JS123-003 | 14 years | $1,800/month | 1.50% | $90/month | $2,300/month | $410 |
| — | — | — | — | — | — | — | — |
| TM456 | TM456-001 | 12 years | $3,000/month | 2% | $150/month | $3,700/month | $550 |
| TM456 | TM456-002 | 12 years | $2,500/month | 1.50% | $125/month | $3,200/month | $525 |
| TM456 | TM456-003 | 10 years | $2,800/month | 1.50% | $135/month | $3,400/month | $465 |
| — | — | — | — | — | — | — | — |
| HY789 | HY789-001 | 15 years | $2,300/month | 1% | $115/month | $2,900/month | $485 |
| HY789 | HY789-002 | 10 years | $2,200/month | 1% | $110/month | $2,800/month | $490 |
| HY789 | HY789-003 | 10 years | $2,500/month | 1.50% | $125/month | $3,100/month | $475 |
| — | — | — | — | — | — | — | — |
| — | — | — | — | — | — | — | — |

### Example Investments Database

Further, aspects of this disclosure may include an owners database 120, which contains the list of owners interested in receiving net lease terms from the net lease network 102. The database contains the owner's name, the owner ID, the property ID, the property address, the square footage, the number of bedrooms, and the number of bathrooms. In some aspects, the owner may send the net lease network 102 more data on the location, such as average utility bills, property tax, insurance costs, condition of the property, condition of current appliances, etc. In some aspects, the owner may send the net lease network 102 the current rates they charge for rent, if the property is vacant or if it currently has renters, the application process the owner uses for renters, etc.

As shown in an example owners database below, the owners database may contain the list of owners interested in receiving net lease terms from the net lease network 102. The database contains the owner's name, the owner ID, the property ID, the property address, the square footage, the number of bedrooms, and the number of bathrooms. The database also the home data or property data received from the property owner 144 if they are selling the property or desire to perform a 1031 exchange, such as if the property owner 144 is interested in selling the property or has sold the property, the original purchase price of the property, the sale price of the property or the price that the property has sold for, and the capital gain on the property or an estimate capital gain of the property if the property is sold at the property owner's 144 asking price. In some aspects, the owner may send the net lease network 102 more data on the location, such as average utility bills, property tax, insurance costs, condition of the property, condition of current appliances, etc. In some aspects, the owner may send the net lease network 102 the current rates they charge for rent, if the property is vacant or if it currently has renters, the application process the owner uses for renters, etc. In some aspects, the home data or property data may include renovations to the property, any damages that have occurred on or in the property, such as fires, flooding, etc., other financial data related to the property, etc.

| Name | Owner ID | Property ID | Address | Square Footage | | Bedrooms | Bathrooms |
|---|---|---|---|---|---|---|---|
| John Smith | JS123 | JS123-001 | 123 main street, Boston, MA | 1,200 | sq. ft. | 2 | 1 |
| John Smith | JS123 | JS123-002 | 34 elm street, Boston, MA | 800 | sq. ft. | 1 | 1 |
| John Smith | JS123 | JS123-003 | 15 Maple Drive, Boston, MA | 1,500 | sq. ft. | 3 | 2 |

| | | | | | | |
|---|---|---|---|---|---|---|
| — | — | — | — | — | — | — |
| — | — | — | — | — | — | — |
| — | — | — | — | — | — | — |

### Example Owners Database

In some cases, the net lease network 102 may collect property data from various sources using web scraping techniques or APIs. The net lease network 102 may perform data cleaning and normalization to ensure consistency and accuracy in the database. Furthermore, data may be indexed for efficient search and retrieval based on location, lease type, and other attributes. In some cases, the net lease network 102 may use machine learning algorithms to analyze property data and identify potential net lease properties, and further apply rules-based filters to remove irrelevant or low-quality listings from the database. Data may be continuously updated and verified through automated processes to maintain data accuracy.

Further, aspects of this disclosure may include a parameters database 122, which contains the parameters created during the process described in the reserve module 106 that are used to determine if a potential property would be profitable for a residential net lease from the net lease network 102. The database contains the location or region, the square foot range of the property, the number of bedrooms, the number of bathrooms, the rent range that could be charged for the property, the average range of fixed and variable costs for the property, and the potential profit range of the property. In some aspects, the database may contain a plurality of locations based on the region of the country, the state the property resides in, the city where the property is located, the town or section of a city where the property is located, etc. In some aspects, the parameters may be determined by the property's square footage, the number of bedrooms the property has, the rent that may be charged for the residential property, or a combination of the parameters.

As an example parameters database shown below, the parameters database may contain the parameters created during the process described in the reserve module 106 used to determine if a potential property would be profitable for a residential net lease from the net lease network 102. The database contains the location or region, the square foot range of the property, the number of bedrooms, the number of bathrooms, the rent range that could be charged for the property, the average range of fixed and variable costs for the property, and the potential profit range of the property. In some aspects, the database may contain a plurality of locations based on the region of the country, the state the property resides in, the city where the property is located, the town or section of a city where the property is located, etc. In some aspects, the parameters may be determined by the property's square footage, the number of bedrooms the property has, the rent that may be charged for the residential property, or a combination of the parameters.

| location | Square Footage Range | Bedrooms | Bathrooms | Rent Range | Fixed Cost Range | Potential Profit Range |
|---|---|---|---|---|---|---|
| Boston, MA | 600-800 | Studio | 1 | $1,600-$2,000 | $80-$120 | $300-$500 |
| Boston, MA | 800-1,000 | 1 | 1 | $1,800-$2,200 | $100-$130 | $400-$600 |
| Boston, MA | 1,000-1,200 | 2 | 1 | $2,200-$2,700 | $110-$150 | $500-$600 |
| — | — | — | — | — | — | — |
| — | — | — | — | — | — | — |
| — | — | — | — | — | — | — |

### Example Parameters Database

Further, aspects of this disclosure may include a reserve database 140 in which the investors 146 investment is held in reserve if the net lease networks 102 expenses are greater than the returns, or profits from the residential rental properties, to ensure payment to the property owners 128 according to the terms of their net lease. The reserve database 140 may also be used to expand a line of credit for the net lease network 102 to add more residential rental properties to the investments database 118 by attracting more property owners 128. The reserve database 140 may be funded entirely through the upfront fees paid by property owners 128. The calculation of the upfront fee paid by the property owner 144 may be based on an underwriting algorithm that identifies the relative risk of each property owner 144 and the market. In some aspects, the reserve database 140 may be stored and managed by a third party, such as a bank or financial institution. In some aspects, the reserve database 140 may be used for unexpected costs such as unexpected vacancy of the residential rental property, capital expenditures, variable costs, etc.

Further, aspects of this disclosure may include a 1031 module 124, which begins by being initiated by the net lease module 104. For example, the 1031 module 124 is initiated when the net lease module 104 receives a 1031 request from a property owner 144. For example, a 1031 request may be a request from the property owner 144 that they are in the process or have the desire to complete a 1031 exchange, which may be a swap of one investment property for another to change the form of the investment without cashing out or recognizing a capital gain. The 1031 module 124 sends a request to the property for the home data, such as the price the property owner 144 bought the property, the price the property owner 144 has sold the property or intends to sell the property, the gains on the investment property, etc.

In some aspects, the property owner 144 may include renovations to the property, any damages that have occurred on or in the property, such as fires, flooding, etc., other financial data related to the property, etc. The 1031 module 124 receives the home data from the property owner 144 and stores the home data in the owner database 120. For example, the 1031 module 124 receives home data including, but not limited to, the price the property owner 144 bought the property, the price the property owner 144 has sold the property or intends to sell the property, the gains on the investment property, etc.

In some aspects, the 1031 module 124 initiates the exchange module 126. The 1031 module 124 initiates the selection module 128. The 1031 module 124 is then continuously polling for a notification from the property owner 144 that the property has been sold. The 1031 module 124 receives a notification from the property owner 144 that the property has been sold. The 1031 module 124 initiates the escrow module 130. The 1031 module 124 initiates the purchase module 132. The 1031 module 124 returns the net lease module 104.

In some cases, the net lease network 102 uses a secure application programming interface (“API”) to enable authorized investors to access property data and initiate exchanges. The net lease network 102 may implement role-based access control to ensure data security and privacy for all parties involved. The net lease network 102 may provide a side-by-side comparison or rank-based analysis of exchange calculations. The net lease network 102 may use advanced algorithms, such as linear programming or machine learning models, to identify optimal property combinations that meet exchange criteria. The net lease network 102 may handle complex constraints, such as nonlinear debt and equity structures, and ensures adherence to 1031 exchange rules.

In some cases, the net lease network 102 may provide detailed reports on potential matches, including relevant property data, exchange calculations, and trade confirmations. The net lease network 102 may further provide custom interfaces for investors to review and modify exchange terms before finalizing the transaction.

The net lease network 102 may serve as a platform that assists with automated documentation for various debt instruments, such as mortgages or loans, and offers tools to manage debt servicing and amortization schedules. The net lease network 102 may further assist with providing tools to account for equity structures, including partnership agreements, and provides mechanisms for assistance with transferring ownership stakes among investors. The net lease network 102 may ensure that all transactions are recorded accurately and in compliance with relevant tax laws. The net lease network 102 may assist inventors in choosing between different financing options when acquiring or selling properties. The net lease network 102 may further offer tools to help investors analyze the financial implications of their exchange decisions, such as cash flow projections or debt-service coverage ratios. The net lease network 102 may provide more or more databases for accounting funds and amounts remunerated in association with their exchanges, ensuring a smooth transfer of assets.

Further, aspects may include an exchange module 126, which begins by being initiated by the 1031 module 124. The exchange module 126 extracts the property owner's 144 home data from the owner database 120. The exchange module 126 filters the owner database 120 on properties for sale. The exchange module 126 extracts properties in the owner database 120 that match the property owner's 144 selling price or price that the property owner 144 has sold their property. The exchange module 126 stores the extracted properties from the owner database 120 that match the property owner's 144 selling price in the sell database 134. The exchange module 126 returns to the 1031 module 124.

Further, aspects may include a selection module 128, which begins by being initiated by the 1031 module. The selection module 128 sends the data in the sell database 134 to the property owner 144. The selection module 128 is continuously polling for the property owner's 144 selections. The selection module 128 receives the property owner's 144 selections from the sell database 134. The selection module 128 stores the property owner's 144 selections in the purchase database 136. The selection module 128 returns to the 1031 module 124.

Further, aspects may include an escrow module 130, which begins by being initiated by the 1031 module 124. The escrow module 130 connects to the third-party financial institution 156. The escrow module 130 creates the escrow account. The escrow module 130 sends the property owner 144 the escrow account data. The escrow module 130 transfers the funds from the sale of the property into the escrow account. The escrow module 130 returns to the 1031 module 124.

Further, aspects may include a purchase module 132, initiated by the 1031 module 124. The purchase module 136 extracts the property owner's 144 home data from the owner's database 120. The purchase module 136 extracts the purchase home data from the purchase database 136. The purchase module 126 compares the extracted data to the checklist database 138. The purchase module 126 determines if the purchase home meets the requirements to qualify for a 1031 exchange. If it is determined that the purchase home meets the requirements for a 1031 exchange the purchase module 136 executes the 1031 exchange. If it is determined that the purchase home does not meet the requirements for a 1031 exchange the purchase module 136 sends a notification to the property owner 144 that the purchase home does not meet the requirements for a 1031 exchange. The purchase module 136 returns to the 1031 module 124.

The net lease network 102 may further provide geocoding techniques or spatial indexing to enable efficient searching of properties within specific regions or proximities concerning particular preferences for respective investors. In some cases, the investors may set location preferences, such as desired neighborhoods or cities, to narrow their search results. The net lease network 102 may also offer tools for investors to analyze market trends and property values within specific locations. As such, the net lease network 102 may allow investors to compare the financial performance of different properties in various locations to inform their investment decisions. The net lease network 102 may further provide detailed information on property taxes, zoning regulations, and other relevant location-specific data.

Further, aspects may include a sell database 134, which contains the list of properties that are for sale or properties that the property owner 144 would be interested in selling that is sent to the property owner 144. Furthermore, the sell database 134 may provide information for a 1031 exchange to see what properties are available in the net lease network 102 that are similar to the property owner 144 has sold or is planning to sell. The database contains the property ID, the address of the property, the square footage of the property, the number of bedrooms in the property, the number of bathrooms in the property, and the selling price of the property. In some aspects, the database may contain renovations to the property, any damages that have occurred on or in the property, such as fires, flooding, etc., other financial data related to the property, etc. In some aspects, the database may contain various home data or property data, such as the type of location, for example, beachfront, beach access, water views, lakefront, etc., the type of property, such as a house, townhouse, apartment, condo, multi-family, etc., amenities within the property, etc.

As shown in an example sell database below, the sell database may display contain the list of properties that are for sale or properties that the property owner 144 would be interested in selling that are sent to the property owner 144, which is performing a 1031 exchange to see what properties are available in the net lease network 102 that is similar to the property owner 144 has sold or is planning to sell. The database contains the property ID, the address of the property, the square footage of the property, the number of bedrooms in the property, the number of bathrooms in the property, and the selling price of the property. In some aspects, the database may contain renovations to the property, any damages that have occurred on or in the property, such as fires, flooding, etc., other financial data related to the property, etc. In some aspects, the database may contain various home data or property data, such as the type of location, for example, beachfront, beach access, water views, lakefront, etc., the type of property, such as a house, townhouse, apartment, condo, multi-family, etc., amenities within the property, etc.

| | | | | Square | | | Selling |
|---|---|---|---|---|---|---|---|
| Name | Owner ID | Property ID | Address | Footage | Bedrooms | Bathrooms | Price |
| [symbol] Smith | [symbol] S123 | [symbol] S123-003 | 15 Maple Drive_Boston_MA | 1_500 sq ft | 3 | 2 | $1_000_000 |
| | | TM456-001 | 98 5th Ave New York NY | 1 [symbol] 200 sq ft | 3 | 2 | $1 [symbol] 000 [symbol] 000 |
| | | HY759-001 | 45 Sunset Drive | 1 [symbol] 700 sq ft | 3 | 2 | $1,000 [symbol] 000 |
| | | | Los Angeles, CA | | | | |
| | | — | — | — | — | — | — |
| | | — | — | — | — | — | — |
| | | — | — | — | — | — | — |

[symbol]

indicates data missing or illegible when filed

### Example Sell Database

Further, aspects may include a purchase database 136, which contains the list of properties that the property owner 144 has selected and has an interest in purchasing from the sell database 134 list that the net lease network 102 provided to the property owner 144. The database contains the property ID, the address of the property, the square footage of the property, the number of bedrooms in the property, the number of bathrooms in the property, and the selling price of the property. In some aspects, the database may serve as the list of properties designated as replacement properties to satisfy the requirements of a 1031 exchange. In some aspects, the database may contain renovations to the property, any damages that have occurred on or in the property, such as fires, flooding, etc., other financial data related to the property, etc. In some aspects, the database may contain various home data or property data, such as the type of location, for example, beachfront, beach access, water views, lakefront, etc., the type of property, such as a house, townhouse, apartment, condo, multi-family, etc., amenities within the property, etc.

As shown in an example purchase database 136 below, the purchase database 136 may display the properties that the property owner 144 has selected and is interested in purchasing from the sell database 134 lists that the net lease network 102 provided to the property owner 144. The database contains the property ID, the address of the property, the square footage of the property, the number of bedrooms in the property, the number of bathrooms in the property, and the selling price of the property. In some aspects, the database may serve as the list of properties designated as replacement properties to satisfy the requirements of a 1031 exchange. In some aspects, the database may contain renovations to the property, any damages that have occurred on or in the property, such as fires, flooding, etc., other financial data related to the property, etc. In some aspects, the database may contain various home data or property data, such as the type of location, for example, beachfront, beach access, water views, lakefront, etc., the type of property, such as a house, townhouse, apartment, condo, multi-family, etc., amenities within the property, etc.

| | | | | Square | | | Selling |
|---|---|---|---|---|---|---|---|
| Name | Owner ID | Property ID | Address | Footage | Bedrooms | Bathrooms | Price |
| [symbol] Smith | [symbol] S123 | JS123-003 | 15 Maple Drive, Boston, MA | 1,500 sq ft | 3 | 2 | $1,000,000 |
| T [symbol] m Mann | [symbol] M456 | TM456-001 | 98 5th Ave New York, NY | 1,200 sq ft | 3 | 2 | $1,000,000 |
| Hugh Young | HY789 | HY789-001 | 45 Sunset Drive, | 1,700 sq ft | 3 | 2 | $1,000,000 |
| | | | Los Angeles, CA | | | | |
| — | — | — | — | — | — | — | — |
| — | — | — | — | — | — | — | — |
| — | — | — | — | — | — | — | — |

[symbol]

indicates data missing or illegible when filed

### Example Purchase Database

Further, aspects may include a checklist database 138, used in the process described in the purchase module 132 to determine if the sold property and replacement property and the process of the swap of properties qualify as a 1031 exchange. The database is used to compare the data from the original property and the data from the replacement property to see if the rules of a 1031 exchange are followed and the corresponding rule if the requirement is not followed. For example, if the replacement property is located within the United States, then the property owner 144 may qualify for a 1031 exchange. However, if the property owner 144 did not use an intermediary or 3rd party to hold the funds from the sale of the original property, then they would not qualify for a 1031 exchange. The data from the original property and the replacement property may need to follow every requirement in the checklist database 138 to qualify for a 1031 exchange.

As shown in an example checklist database below, the checklist database may used in the process described in the purchase module 132 to determine if the sold property and replacement property and the process of the swap of properties qualify as a 1031 exchange. The database is used to compare the data from the original property and the data from the replacement property to see if the rules of a 1031 exchange are followed and the corresponding rule if the requirement is not followed. For example, if the replacement property is located within the United States, then the property owner 144 may qualify for a 1031 exchange. However, if the property owner 144 did not use an intermediary or 3rd party to hold the funds from the sale of the original property, then they would not qualify for a 1031 exchange. The data from the original property and the replacement property may need to follow every requirement in the checklist database 138 to qualify for a 1031 exchange. Functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed aspects.

| Rule | f Not |
|---|---|
| Located [symbol] the U S | Does Not Qual [symbol] f [symbol] |
| Sa [symbol] e Funds Placed in Escrow | Does Not Qual [symbol] f [symbol] |
| Designate Replacement Property Within 45 Days of Sale | Does Not Qual [symbol] f [symbol] |
| Closed on New Property Within 180 Days of Sale of Old Property | Does Not Qual [symbol] f [symbol] |
| Cash Leftover from Sale | Yes [symbol] Pay Taxes on Leftover Cash as a Capital Ga n |
| — | — |
| — | — |
| — | — |

[symbol]

indicates data missing or illegible when filed

### Example Checklist Database

In some cases, the checklist may be based on set parameters that are generated based on the net lease parameters. In some cases, the set parameters are dynamic based on the properties associated with one or more investors that are not respective owners of the respective properties associated with an initial exchange amount. The initial exchange amount may be associated with a property that is sold or on sale.

Further, aspects may include a reserve database 140 in which the investors 146 investment is held in reserve if the net lease networks 102 expenses are greater than the returns, or profits from the residential rental properties, to ensure payment to the property owners 144 according to the terms of their net lease. The reserve database 140 may also be used to expand a line of credit for the net lease network 102 to add more residential rental properties to the investments database by attracting more property owners 144. The reserve database 140 may be funded entirely through the upfront fees paid by property owners 144. The calculation of the upfront fee paid by the property owner 144 may be based on an underwriting algorithm that identifies the relative risk of each property owner 144 and the market. In some aspects, the reserve database 140 may be stored and managed by a third party, such as a bank or financial institution. In some aspects, the reserve database 140 may be used for unexpected costs such as unexpected vacancy of the residential rental property, capital expenditures, variable costs, etc.

Further, aspects may include a plurality of property managers 142, which may be a person or firm charged with operating a real estate property for a fee. For example, the property manager 142 may be required to find/evict tenants, deal with tenants, and coordinate with the net lease network 102. In addition, such arrangements may require the property manager 120 to collect rent and pay necessary expenses and taxes, making periodic reports to the owner, or the net lease network 102 may delegate specific tasks and deal with others directly. A property manager 142 may arrange for a wide variety of services, as may be requested by the net lease network 102, for a fee. Where a dwelling (vacation home, second home) is only periodically occupied, the property manager 142 might arrange for heightened security monitoring, house-sitting, storage and shipping of goods, and other local sub-contracting necessary to make the property comfortable for when a new tenant rents the property.

Further, aspects may include a plurality of property owners 144, which may be residential property owners that engage in a long-term net lease with the net lease network 102 to eliminate variability that comes with renting residential properties and decrease the time spent on making the residential rental property profitable. The long-term net lease with the net lease network 102 allows the property owner 122 to remove themselves from the responsibility of managing the property, paying taxes on the property, paying insurance on the property, maintaining the property, paying for utilities, paying for capital expenditures of the property, etc. and moving the responsibility to the net lease network 102 in exchange for net lease payment allowing the net lease network 102 controlling rights of the property.

How does the net lease network coordinate with the 1031 exchange?

Further, aspects may include a plurality of investors 146, which provide investment to the net lease network 102 to find residential properties to engage in long-term net leases in exchange for a percentage of the profits made on the residential properties as the return on the investment. Further, aspects may include a plurality of vendors 148, which may be the source of where the property managers 142 are assigned to the various residential rental properties and take care of the management of the property, management of the leases for the tenants, manage the maintenance of the property, track and collect rent from the tenants, track and maintain the relationship with the tenants, and manage the vacancy of the residential property.

Further, aspects may include a plurality of property renters 150, which sign a rental agreement with the net lease network 102 to rent the residential property. The renters 134 may pay a monthly rental fee to live in the property, and the agreement may cover certain costs, such as heat, water, electricity, internet, etc. In some aspects, the net lease network 102 may use a plurality of vendors 148 to assign property managers 142 to the residential rental property to take care and maintain the property on behalf of the net lease network 102 while collecting rent fees, paying fixed and variable costs, and maintain the relationship with the renters 134.

Further, aspects may include an expenses network 152, which includes a plurality of market data for the properties engaged or about to be engaged in a long-term net lease with the net lease network 102. The expenses network 152 may contain data for specific locations, cities, regions, or states to allow the most up-to-date market data for the net lease network 102 to be used to create the net lease terms. The expenses network 152 may contain, for each specific location, the starting market rent, the market growth rate, the inflation rate, the vacancy rate, the rent collectability rate, the home price appreciation, and the operating expenses, which are stored as a data file and may contain the local taxes, the insurance rates, the management fees, the maintenance budget, the homeowner's association fees, the cost of utilities, and the asset management fees. In some aspects, the expenses network 152 may be connected to a plurality of third-party networks to compile the market data. In some aspects, the expenses network 152 may continuously update the market data or may collect the specific market data based on a request from the net lease network 102. In some aspects, the expenses network 152 may store the market data in a plurality of databases to extract and send the data as it is requested from the net lease network 102.

Further, aspects may include a cloud 154, which is a distributed network of computers comprising servers and databases. A cloud 154 may be a private cloud 154, where access is restricted by isolating the network, preventing external access, or using encryption to limit access to only authorized users. Alternatively, a cloud 154 may be a public cloud 154 where access is widely available via the internet. A public cloud 154 may not be secured or include limited security features.

Further, aspects may include a 3rd party financial institution 156, which is used as an intermediary to hold the funds from the sale of the original property if the property owner 144 is completing a 1031 exchange. The 3rd party financial institution 156 may be a bank, mortgage service, or business entity that provides services as intermediaries for different financial and monetary transactions, including providing escrow accounts.

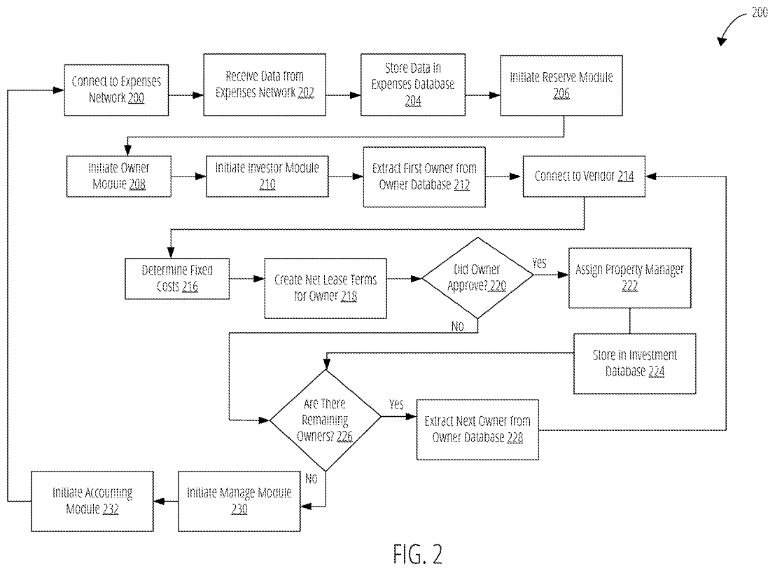

FIG. 2 illustrates an example method performed by a net lease module.

The process begins with the net lease module 104 connecting, at step 200, to the expenses network 152. For example, the net lease module 104 connects to the expenses network 152 through the cloud 154. In some aspects, the connection may include a request from the net lease module 104 to receive the market data stored in the expenses network 152. In some aspects, if the expenses network 152 connects to a plurality of third-party networks for the market data, the net lease module 104 may connect to each third-party network to request the market data individually. In some aspects, the request from the net lease module 104 may include a specific location, city, region, state, etc., for the desired market data.

The net lease module 104 receives, at step 202, the data from the expenses network 152. For example, the net lease module 104 receives the market data from the expenses network 152, such as the starting market rent, the market growth rate, the inflation rate, the vacancy rate, the rent collectability rate, the home price appreciation, the operating expenses which are stored as a data file and may contain the local taxes, the insurance rates, the management fees, the maintenance budget, the homeowner's association fees, the cost of utilities, and the asset management fees.

The net lease module 104 stores, at step 204, the data from the expenses network 152 in the expenses database 116. For example, the net lease module 104 stores the market data in the expenses database 116, such as the starting market rent, the market growth rate, the inflation rate, the vacancy rate, the rent collectability rate, the home price appreciation, the operating expenses which are stored as a data file and may contain the local taxes, the insurance rates, the management fees, the maintenance budget, the homeowner's association fees, the cost of utilities, and the asset management fees.

The net lease module 104 initiates, at step 206, the reserve module 106. For example, the reserve module 106 begins by being initiated by the net lease module 104. The reserve module 106 extracts the first region from the expenses database 116. The reserve module 106 creates the region's net lease parameters. The reserve module 106 stores the parameters in the parameters database 122. The reserve module 106 determines if any more regions are remaining in the expenses database 116. If it is determined that more regions remain in the expenses database 116, the reserve module 106 extracts the next region from the expenses database 116, and the process returns to creating the parameters for the net lease for the region. If it is determined that no more regions are remaining in the expenses database 116, the reserve module 106 returns to the net lease module 104.

The net lease module 104 initiates, at step 208, the owner module 108. For example, the owner module 108 begins by being initiated by the net lease module 104. The owner module 108 connects to the property owners 144. The owner module 108 identifies the potential property owners that may have a property that is within the parameters for a net lease. The owner module 108 sends a notification to the property owners 144 with a property that fulfills the parameters for a net lease. The owner module 108 determines if the owner approves the notification. If the owner approves of the notification, the owner module 108 receives the property details from the property owner 128. The owner module 108 stores the data in the owner database 120. if it is determined that the owner did not approve of the notification or after the data is stored in the owner database 120, the owner module 108 returns to the net lease module 104.

The net lease module 104 initiates, at step 210, the investor module 110. For example, the investor module 110 begins by being initiated by the net lease module 104. The investor module 110 connects to the investors 146. The investor module 110 identifies potential investors for investment into the reserve database 140. The investor module 110 sends a notification to the investors 146. The investor module 110 receives the investment from the investors 124. The investor module 110 stores the received investment from the investors 146 in the reserve database 24. The investor module 110 returns to the net lease module 104.

The net lease module 104 extracts, at step 212, the first owner from the owner database 120. For example, the net lease module 104 extracts the data entry for the first owner and the first property for the owner, such as the property's location, the square footage, the number of bedrooms, and the number of bathrooms. In some aspects, the data may include the average cost of utilities, property tax, insurance costs, condition of the property, condition of current appliances, the current rates they charge for rent, if the property is vacant or if it currently has renters, the application process the owner uses for renters, etc.

The net lease module 104 connects, at step 214, to the vendors 148. For example, the net lease module 104 connects to the vendors 148 through the cloud 154 to find the average fixed and variable costs for the vendors in the region, city, state, etc., where the property is located. In some aspects, the net lease module 104 may have a plurality of agreements with a plurality of vendors 148 in a plurality of locations to assign property managers to maintain the residential properties.

The net lease module 104 determines, at step 216, the fixed and variable costs for the property. For example, the net lease module 104 may determine the fixed and variable costs for each property, such as by invoices inputted by vendors 148 or by the property managers 142, extracting the operating expenses from the expense database 116, etc.

The net lease module 104 creates, at step 218, the net lease terms for the property owner. For example, the net lease module 104 may determine the residential property's location and then use the data stored in the expenses database 116 as inputs into an algorithm that outputs the net lease payment terms for the property owner 128. For example, if the residential rental property is located in Boston, MA, then the starting market rent, the market growth rate, the inflation rate, the vacancy rate, the rent collectability rate, the home price appreciation, the operating expenses such as the local taxes, the insurance rates, the management fees, the maintenance budget, the homeowners association fees, the cost of utilities, and the asset management fees would be used as inputs into the algorithm to determine the net lease payment. For example, the algorithm may use the average rent per square footage and the square footage of the property owners 144 residential properties to determine the cost of rent for the property, such the average rent per square foot is $4.50 in Boston, MA, and the property owners 144 property is 800 square feet, resulting in a rent price of $3,600 per month.

In some cases, a machine-learning algorithm may be used to output the set of net lease terms, wherein the machine-learning algorithm determines the weights based on training data including past net lease terms associated with one or more regions. For example, the net lease network 102 may use unsupervised learning algorithms, such as clustering or dimensionality reduction techniques, to identify trends and patterns in historical exchange data. Furthermore, the net lease network 102 may employ supervised learning models, like regression or neural networks, to make predictions based on these trends and to optimize property selection and exchange processes. The net lease network 102 may continually update its models as new data becomes available, ensuring accurate and up-to-date forecasts.

The net lease network 102 may also use ensemble methods to combine the predictions of multiple models for improved accuracy and robustness. The net lease network 102 may offer tools for investors to customize their machine learning models based on their specific investment strategies and preferences. In some cases, the net lease network 102 may provide visualizations of predicted exchange amounts over time, helping investors understand market trends and adjust their investment strategies accordingly.

In some cases, the net lease network 102 may use statistical analysis methods to analyze historical exchange amount data and employ machine learning models, like long short-term memory (LSTM) networks, to predict future exchange amounts based on historical trends. The net lease network 102 may further provide visualizations of predicted exchange amounts over time and by location, helping investors understand market conditions and identify opportunities. Furthermore, the net lease network 102 may offer tools for investors to analyze seasonality patterns in the data and adjust their investment strategies accordingly. The net lease network 102 may also use real-time market data and news feeds to adapt to changing market conditions update its predictions, and send alerts when significant shifts in exchange amount are detected, enabling them to take advantage of market opportunities.

The other inputs, such as the market growth rate, the inflation rate, the vacancy rate, the rent collectability rate, the home price appreciation, the operating expenses, etc., may be used in the algorithm as weighted averages or percentages to increase or decrease the rental price of the property. The algorithm may offer the property owner 128 net lease terms based on a percentage of the possible rent that the net lease network 102 could charge tenants, such as 75% or $2,700 per month, over the length of 15 years, allowing the property owner 128 to be free of the responsibilities associated with renting a property and providing them with a steady payment for the residential rental property. In some aspects, the property owner 128 may be offered an annual increase percentage of the net lease payment due to inflation, market growth rate, etc.

The net lease module 104 determines, at step 220, if the property owner 128 approved the net lease terms. For example, the property owner 128 may send the signed agreements back to the net lease module 104 or net lease network 102 to approve the net lease terms. In some aspects, the property owner 128 may have a login, such as a username and password, account, access to the net lease network 102, etc., to approve the net lease terms. In some aspects, an administrator of the net lease network 102 may collect the signed agreements from the property owners 144 and store the data in the net lease network 102 to approve the net lease terms.

If it is determined that the property owner 128 approved of the net lease terms, the net lease module 104 assigns, at step 222, a property manager 126 to the property. For example, the net lease module 104 may assign a property manager 126 to the residential property. In some aspects, the property manager 126 may be assigned by one of the vendors 148 the net lease network 102 has an agreement with. In some aspects, the property manager 126 may be a person or firm charged with operating a real estate property for a fee. For example, the property manager 126 may be required to find/evict tenants, deal with tenants, and coordinate with the net lease network 102. In addition, such arrangements may require the property manager 126 to collect rents and pay necessary expenses and taxes, making periodic reports to the owner, or the net lease network 102 may delegate specific tasks and deal with others directly.

The net lease module 104 stores, at step 224, the data in the investments database. For example, the net lease module 104 stores the data created from the net lease terms in the investments database 118, such as a property owner ID, the property ID, the length of the lease or the years remaining on the net lease, the lease payment to the property owner 128, the annual increase of the net lease payment to the property owner, the fixed and variable costs per month for the property, the rent collected per month for the property, etc. If it is determined that the property owner 128 did not approve of the net lease terms or after the data is stored in the investments database 118, the net lease module 104 determines, at step 226, if there are any property owners 144 remaining in the owner database 120.

If it is determined that more owners are remaining in the owner database 120, the net lease module 104 extracts the next owner from the owner database 120, and the process returns to connecting to the vendors 148.

If it is determined that no more owners remain in the owner database 120, the net lease module 104 initiates, at step 230, the manage module 112. For example, the manage module 112 begins by being initiated by the net lease module 104. The manage module 112 extracts the first data entry in the investments database 118. The manage module 112 determines the fixed and variable costs for the property. The manage module 112 pays the costs of the property. The manage module 112 collects rent from the renters 134. The manage module 112 stores the rent in the reserve database 140. The manage module 112 determines if there are more data entries remaining in the investments database 118. If it is determined that there are more data entries remaining in the investments database 118, the manage module 112 extracts the next data entry from the investments database 118. If it is determined that there are no more data entries remaining in the investments database 118, the manage module 112 returns to the net lease module 104.

Then the net lease module 104 initiates, at step 232, the payment module 114. For example, the payment module 114 begins by being initiated by the net lease module 104. The payment module 114 determines the payment to the property owners 144. The payment module 114 sends the payment to the property owners 144. The payment module 114 determines the profits of the residential investments. The payment module 114 sends the profits of the residential investments to the investors 146. The payment module 114 returns to the net lease module 104.

The net lease module 104 determines, at step 234, if a 1031 request was received from a property owner 144. If it is determined that a 1031 request was not received, then the net lease module 104 returns to connecting to the expenses network 152. If it is determined that the 1031 request was received from a property owner 144, the net lease module 104 initiates, at step 236, the 1031 module 124. For example, the 1031 module 124 begins by being initiated by the net lease module 104. For example, the 1031 module 124 is initiated when the net lease module 104 receives a 1031 request from a property owner 144. For example, a 1031 request may be a request from the property owner 144 that they are in the process or have the desire to complete a 1031 exchange, which may be a swap of one investment property for another to change the form of the investment without cashing out or recognizing a capital gain.

The 1031 module 124 sends a request to the property for the home data, such as the price the property owner 144 bought the property, the price the property owner 144 has sold the property or intends to sell the property, the gains on the investment property, etc. In some aspects, the property owner 144 may include renovations to the property, any damages that have occurred on or in the property, such as fires, flooding, etc., other financial data related to the property, etc. The 1031 module 124 receives the home data from the property owner 144. For example, the 1031 module 124 receives home data including, but not limited to, the price the property owner 144 bought the property, the price the property owner 144 has sold the property or intends to sell the property, the gains on the investment property, etc. In some aspects, the property owner 144 may include renovations to the property, any damages that have occurred on or in the property, such as fires, flooding, etc., other financial data related to the property, etc.

The 1031 module 124 stores the home data in the owner database 120. For example, the data that is stored in the owner database 120 may be the price the property owner 144 bought the property, the price the property owner 144 has sold the property or intends to sell the property, the gains on the investment property, etc. In some aspects, the property owner 144 may include renovations to the property, any damages that have occurred on or in the property, such as fires, flooding, etc., other financial data related to the property, etc.

The 1031 module 124 initiates the exchange module 126. The 1031 module 124 initiates the selection module 128. The 1031 module 124 is then continuously polling for a notification from the property owner 144 that the property has been sold. The 1031 module 124 receives a notification from the property owner 144 that the property has been sold. The 1031 module 124 initiates the escrow module 130. The 1031 module 124 initiates the purchase module 132. The 1031 module 124 returns the net lease module 104.

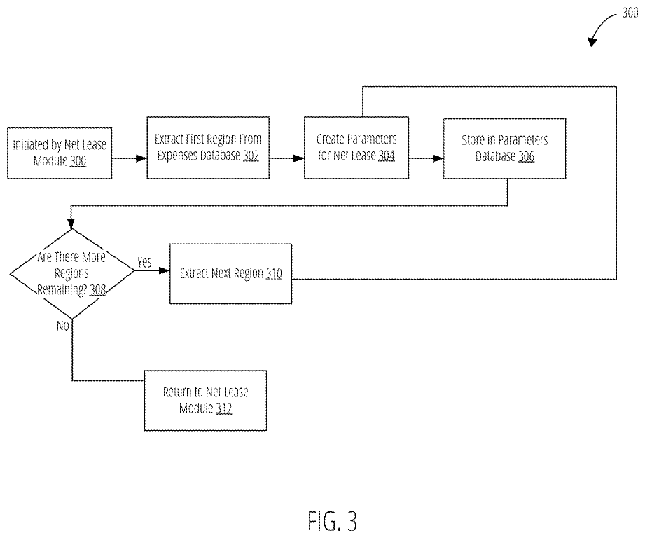

FIG. 3 illustrates an example method performed by a reserve module.

FIG. 3 displays the reserve module 106. The process begins with the reserve module 106 being initiated, at step 300, by the net lease module 104. In some aspects, the reserve module 106 may not need to be initiated and is continuously running in the background of the net lease network 102.

The reserve module 106 extracts, at step 302, the first region from the expenses database 116. For example, the reserve module 106 extracts the first region from the expenses database 116, such as the state, city, town, etc., that the expenses data and market data are related to.

The reserve module 106 creates, at step 304, the parameters for the net lease for the region. For example, the reserve module 106 may use the data stored in the expenses database to create parameters for residential net leases to identify residential properties that would be profitable with a residential net lease. For example, if the reserve module 106 may calculate an average range that could be charged for rent depending on the cost per square foot, such as if renters in Boston, MA, typically pay $4.50 per square foot of a property and the average square footage of a studio apartment is 800 square feet to 1,000 square feet, the average rent for a studio apartment may be $3,600 to $4,500.

In some aspects, the calculations may incorporate the number of bedrooms and bathrooms to adjust the average rental price based on square footage. In some aspects, the calculations may incorporate the area's average fixed and variable costs of properties. In some aspects, the calculations may use the average rental price and average fixed and variable costs to determine the average profit of a rental property. In some aspects, the calculations may use a percentage of the average rental price to determine the average payment to a property owner 128 to determine the profits, for example, if the average rent price was $3,600 a month. The owner 128 typically received a payment of 80% for a net lease agreement, then the calculations would subtract the 80% for the net lease and the fixed and variable costs to determine the average monthly profit of a residential rental property.

The reserve module 106 stores, at step 306, the parameters in the parameters database 122. For example, the reserve module 106 may store all the data from the calculating the parameters in the parameters database 122, such as the location or region, the square foot range of the property, the number of bedrooms, the number of bathrooms, the rent range that could be charged for the property, the average range of fixed and variable costs for the property, and the potential profit range of the property.

The reserve module 106 determines, at step 308, if any more regions are remaining in the expenses database 116. For example, if there are more regions, cities, towns, etc., in the expenses database 116, the reserve module 106 extracts the next region, and the process returns to determine the region's parameters.

If it is determined that more regions remain in the expenses database 116, the reserve module 106 extracts, at step 310, the next region from the expenses database 116, and the process returns to creating the parameters for the net lease for the region. If it is determined that no more regions are remaining in the expenses database 116, the reserve module 106 returns, at step 312, to the net lease module 104.

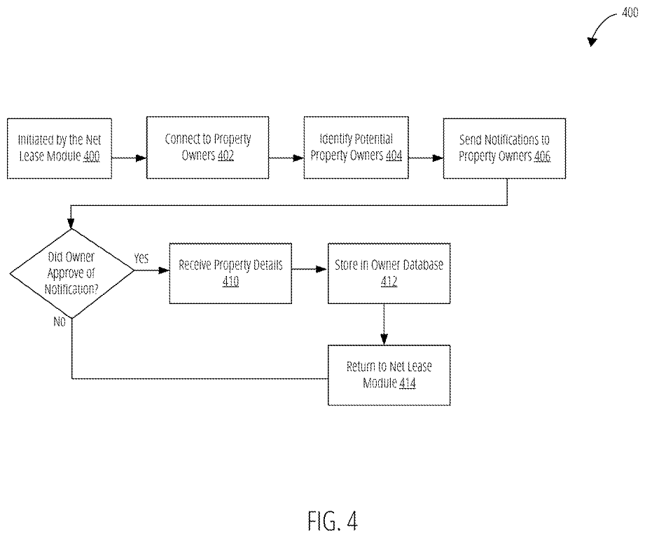

FIG. 4 illustrates an example method performed by an owner module.

FIG. 4 displays the owner module 108. The process begins with the owner module 108 being initiated, at step 400, by the net lease module 104. In some aspects, the owner module 108 may not need to be initiated and is continuously running in the background of the net lease network 102.

The owner module 108 connects, at step 402, to the property owners 144. For example, the owner module 108 connects to the property owners 144 through the cloud 154, owners 128 may log in to the net lease network 102, sign up to the net lease network 102, etc. In some aspects, the owner module 108 may find potential property owners 144 through rental listings, apartment listings, etc., and offer the property owner 128 the net lease terms once they are created. In some aspects, the property owner 128 may be required to input their information, such as name, location of the residential rental property, e-mail address, etc., to receive the net lease terms from the owner module 108.

The owner module 108 identifies, at step 404, the potential property owners that may have a property that is within the parameters for a net lease. For example, the owner module 108 may identify residential properties that would be candidates for residential net leases by comparing the readily available data on the properties to the parameters stored in the parameter database 122. For example, the owner 128 may send data to the owner module 108, such as square footage, number of bedrooms, number of bathrooms, current rent, etc., and the owner module 108 compares the received data to the parameters database 122 to determine if the received data falls within the parameters. In some aspects, the owner module 108 may use third-party sources to extract the data on the residential properties to determine if the property falls within the range of the parameters stored in the parameter database 122.

The owner module 108 sends, at step 406, a notification to the property owners 144 that have a property that fulfills the parameters for a net lease. For example, if the residential property data is within the parameters of the parameter database 122, then the owner module 108 may send a notification, such as an e-mail, automated phone call, notification through the net lease network 102, etc., to the owner. In some aspects, the owner module 108 may send the owner an estimate of a potential net lease agreement.

The owner module 108 determines, at step 408, if the owner approves the notification. For example, the owner module 108 determines if the owner 128 responds to the notification by e-mail, logging onto the net lease network 102, etc. If the owner approves the notification, the owner module 108 receives, at step 410, the property details from the property owner 128. For example, the owner 128 sends the owner module the data related to the residential property, such as the square footage, number of bedrooms, number of bathrooms, current condition of the property, the current condition of the appliances, current rent, the current property management group, etc.

The owner module 108 stores, at step 412, the data in the owner database 120. For example, the owner module 108 stores the received data in the owner database 120, such as the owner's name, the owner ID, the property ID, the property address, the square footage, the number of bedrooms, and the number of bathrooms, average utility bills, property tax, insurance costs, condition of the property, condition of current appliances, current rates they charge for rent, if the property is vacant or if it currently has renters, the application process the owner uses for renters, etc. if it is determined that the owner did not approve of the notification or after the data is stored in the owner database 120 the owner module 108 returns, at step 414, to the net lease module 104.

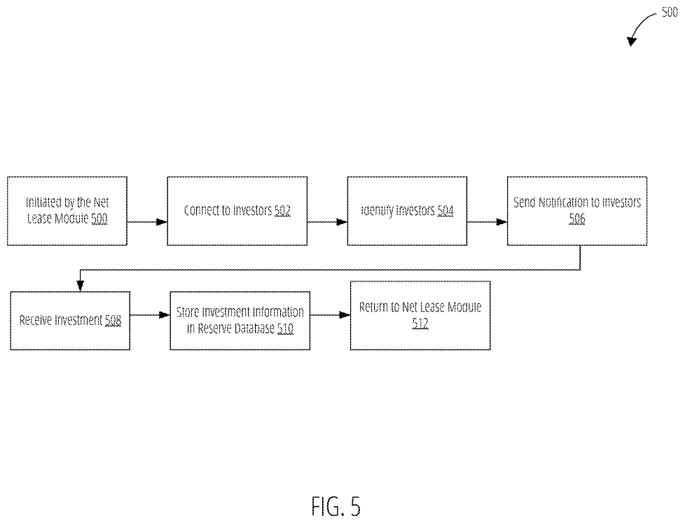

FIG. 5 illustrates an example method performed by an investor module.

FIG. 5 displays the investor module 110. The process begins with the investor module 110 being initiated, at step 500, by the net lease module 104. In some aspects, the investor module 110 may not need to be initiated and is continuously running in the background of the net lease network 102.

The investor module 110 connects, at step 502, to the investors 146. For example, the investor module 110 may connect to the investors 146 through the cloud 154, investors may log in to the net lease network 102, sign up to the net lease network 102, etc. In some aspects, the investor module 110 may provide the investors 146 with certain documents such as income statements, balance sheets, capital requirements, investor agreements, term sheets, business plans, etc.

The investor module 110 identifies, at step 504, potential investors for investment into the reserve database 140. For example, the investor module 110 may identify potential investors for investment by collecting e-mails of investors that visit the net lease network 102, sign up for the net lease network 102 by creating a username and password, etc.

The investor module 110 sends, at step 506, a notification to the investors 146. For example, the investor module 110 may send an e-mail, or other notification, through the net lease network 102, etc., to notify the investors. In some aspects, the investor module 110 may provide the investors 146 with certain documents such as income statements, balance sheets, capital requirements, investor agreements, term sheets, business plans, etc.

The investor module 110 receives, at step 508, the investment from the investors 124. For example, the investor module 110 receives an investment from the investor 130, which may include a certain amount of capital to invest in the net lease agreements for residential rental properties. In some aspects, the investor module 110 may send the investor 130 the investment agreement, contract, etc.

The investor module 110 stores, at step 510, the received investment from the investors 146 in the reserve database 140. For example, the investor module 110 stores the received investment in the reserve database 140 in which the investors 146 investment is stored as capital if the net lease networks 102 expenses are greater than the returns, or profits from the residential rental properties, to ensure payment to the property owners 144 according to the terms of their net lease. The reserve database 140 may also be used to expand a line of credit for the net lease network 102 to add more residential rental properties to the investments database by attracting more property owners 144. In some aspects, the reserve database 140 may be stored and managed by a third party, such as a bank or financial institution. In some aspects, the reserve database 140 may be used for unexpected costs such as unexpected vacancy of the residential rental property, capital expenditures, variable costs, etc. The investor module 110 returns, at step 512, to the net lease module 104.

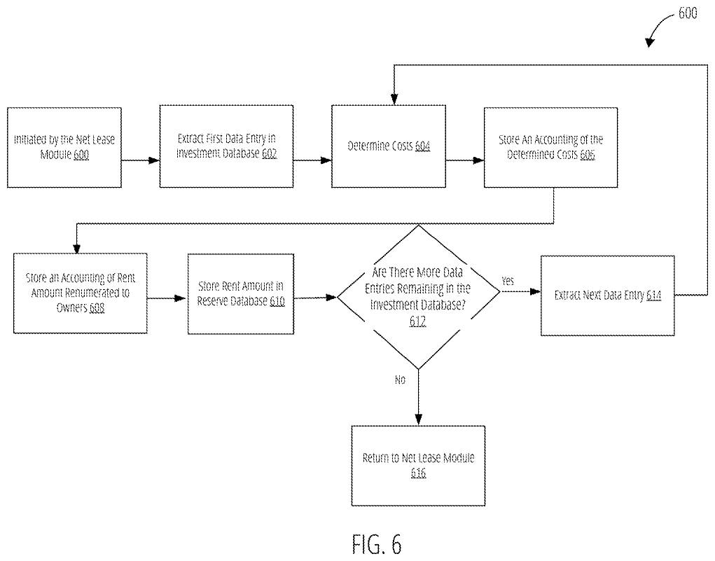

FIG. 6 illustrates an example method performed by a manage module.

FIG. 6 displays the manage module 112. The process begins with the manage module 112 being initiated, at step 600, by the net lease module 104. In some aspects, the manage module 112 may not need to be initiated and is continuously running in the background of the net lease network 102.

The manage module 112 extracts, at step 602, the first data entry in the investments database 118. For example, the manage module extracts the first data entry in the investments database 118, such as the first property, including The manage module 112 determines, at step 604, the fixed and variable costs for the property. For example, the manage module 112 may determine the fixed and variable costs for each property, such as by invoices inputted by vendors 126 or property managers 142, extracting the operating expenses from the expense database 116, etc. In some aspects, the property manager 120 may be responsible for sending invoices of each property's fixed and variable costs, and the manage module 112 may extract the funds from the reserve database 140 to pay for the invoices.

The manage module 112 pays, at step 606, the costs of the property. For example, the manage module 112 may pay for the costs of the property by sending the payment from the reserve database 140 to the vendors 148 or property manager 126. In some aspects, the vendors 148 or property manager 126 may submit invoices to be paid through the net lease network 102, and the manage module 112 extracts the payment from the reserve database 140 and sends the payment to the vendors 148 or property manager 126.

The manage module 112 collects, at step 608, rent from the renters 134. For example, the manage module 112 may collect the rent from the residential rental properties by sending a notification to the property manager 126 or receiving a notification from the property manager 126 to determine if the rent for the rental property has been collected for the month. In some aspects, the property manager 126 may use the manage module 112 or net lease network 102 to collect rent from the tenants, such as by the tenant's signing into the net lease network 102 and sending the payment electronically.

The manage module 112 stores, at step 610, the rent in the reserve database 140. For example, the manage module 112 stores the rent collected and the amount collected for each rental property in the reserve database 140. In some aspects, the rent may be stored in the reserve database 140 to be used to pay for the fixed and variable costs of the rental property. In some aspects, the reserve database 140 may be used to pay for fixed or variable costs for other rental properties being managed by the net lease network 102. In some aspects, the rent payment may be stored in the reserve database 140 by connecting the renter 134 to the net lease network 102 and submitting the payment, which is automatically transferred to the financial account of the reserve database 140.

The manage module 112 determines, at step 612, if there are more data entries remaining in the investments database 118. For example, the manage module 112 extracts the next data entry to pay the costs of the next property and collect the rent of the next property until all of the properties in the investments database 118 have paid the associated property costs and collected rent from all of the renters 134.

If it is determined that there are more data entries remaining in the investments database 118, the manage module 112 extracts, at step 614, the next data entry from the investments database 118. If it is determined that no more data entries remain in the investments database 118, the manage module 112 returns, at step 616, to the net lease module 104.

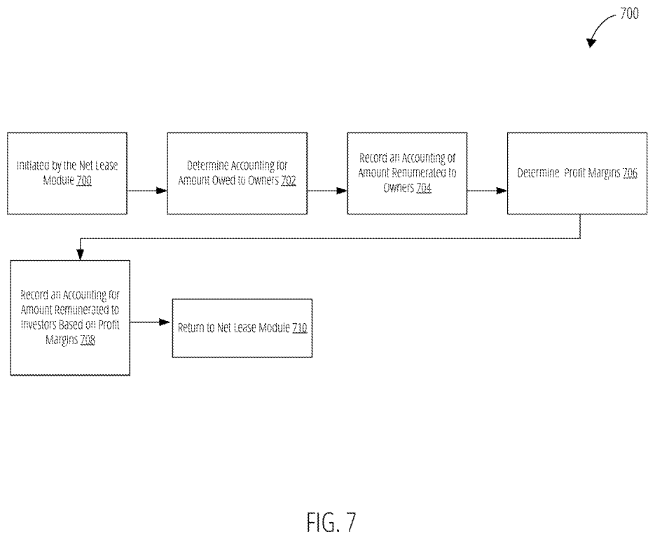

FIG. 7 illustrates an example method performed by an accounting module.

FIG. 7 displays the payment module 114. The process begins with the payment module 114 being initiated, at step 700, by the net lease module 104. In some aspects, the payment module 114 may not need to be initiated and is continuously running in the background of the net lease network 102.

The payment module 114 determines, at step 702, the payment to the property owners 144. For example, the payment module 114 may determine the payment to the property owner 128 by extracting the net lease payment from the investments database 118 and extracting the amount from the reserve database 140 to send to the property owner 128. In some aspects, if a property owner 128 has multiple properties on the net lease network 102, the payment module 114 may filter the investments database 118 on the property owner 128 ID and determine the sum of all the net lease payments owed to the property owner 128 and extract the funds from the reserve database 140 to send to the property owner 128. In some aspects, if there is a plurality of property owners 144, the payment module 114 may extract a first property owner 128 and determine the payment, send the payment, and then select the next property owner 128 until all the property owners 144 are stored in the investments database 118 are paid. In some aspects, the payments may be determined by the net lease terms and sent based on a specific schedule and may be paid out monthly, quarterly, annually, etc.

The payment module 114 sends, at step 704, the payment to the property owners 144. For example, the payment module 114 may send the net lease payment to the property owner 128 by extracting the amount owed to the property owner 128 from the reserve database 140 and sending the payment electronically to the property owner 128.

The payment module 114 determines, at step 706, the profits of the residential investments. For example, the payment module 114 may determine the profits of the residential investments by extracting the payment to the property owners 144, the cost of the properties, and the rent collected on the property. Then the payment module 114 may add the payment to the property owners and the cost of the property together and subtract the total from the rent collected to determine the monthly profit of the property. The payment module 114 may add the sum of all the profits for the residential rental properties to determine the total profit. In some aspects, the profits may be stored in the investments database 118. In some aspects, the profits may be determined monthly, quarterly, annually, etc.

The payment module 114 sends, at step 708, the profits of the residential investments to the investors 146. For example, the payment module 114 may send the profits to investors 146 that had invested in the net lease network 102. For example, the investors 146 may have a certain percentage of profits they are entitled to based upon their investor agreement. For example, if an investor 130 agreed to invest $1,000 for 1% of the profits and the total monthly profits were $4,000, then the investor 130 would be entitled to $40 for the monthly profits.

In some aspects, the investor agreements may be stored in the net lease network 102. In some aspects, the payment module 114 may extract each investor 130 agreement and the percentages of the profits that they are owed and extract the amount from the reserve database 140 to pay the investors 146 their return on investment. In some aspects, the investors 146 may be paid out monthly, quarterly, annually, etc. The payment module 114 returns, at step 710, to the net lease module 104.

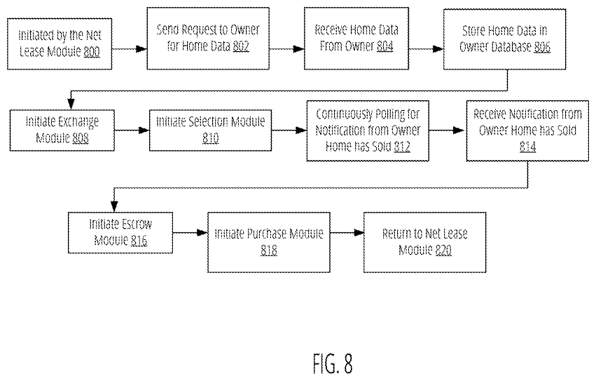

FIG. 8 illustrates an example method performed by a 1031 module.

FIG. 8 displays the 1031 module 124. The process begins with the 1031 module 124 being initiated, at step 800, by the net lease module 104. For example, the 1031 module 124 is initiated when the net lease module 104 receives a 1031 request from a property owner 144. For example, a 1031 request may be a request from the property owner 144 that they are in the process or have the desire to complete a 1031 exchange, which may be a swap of one investment property for another to change the form of the investment without cashing out or recognizing a capital gain.

The 1031 module 124 sends, at step 802, a request to the property for the home data, such as the price the property owner 144 bought the property, the price the property owner 144 has sold the property or intends to sell the property, the gains on the investment property, etc. In some aspects, the property owner 144 may include renovations to the property, any damages that have occurred on or in the property, such as fires, flooding, etc., other financial data related to the property, etc.

The 1031 module 124 receives, at step 804, the home data from the property owner 144. For example, the 1031 module 124 receives home data including, but not limited to, the price the property owner 144 bought the property, the price the property owner 144 has sold the property or intends to sell the property, the gains on the investment property, etc. In some aspects, the property owner 144 may include renovations to the property, any damages that have occurred on or in the property, such as fires, flooding, etc., other financial data related to the property, etc.

The 1031 module 124 stores, at step 806, the home data in the owner database 120. For example, the data stored in the owner database 120 may be the price the property owner 144 bought the property, the price the property owner 144 has sold the property or intends to sell the property, the gains on the investment property, etc. In some aspects, the property owner 144 may include renovations to the property, any damages that have occurred on or in the property, such as fires, flooding, etc., other financial data related to the property, etc.

The 1031 module 124 initiates, at step 808, the exchange module 126. For example, the exchange module 126 begins by being initiated by the 1031 module 124. The exchange module 126 extracts the property owner's 144 home data from the owner database 120. The exchange module 126 filters the owner database 120 on properties for sale. The exchange module 126 extracts properties in the owner database 120 that match the property owner's 144 selling price or price that the property owner 144 has sold their property. In some cases, more than one property may be bundled together to match the property owner's 144 selling price or price, or exchange amount. The exchange module 126 may store the extracted properties from the owner database 120 that match the property owner's 144 selling price in the sell database 134. The exchange module 126 returns to the 1031 module 124.

The 1031 module 124 initiates, at step 810, the selection module 128. For example, the selection module 128 begins by being initiated by the 1031 module. The selection module 128 sends the data in the sell database 134 to the property owner 144. The selection module 128 is continuously polling for the property owner's 144 selections. The selection module 128 receives the property owner's 144 selections from the sell database 134. The selection module 128 stores the property owner's 144 selections in the purchase database 136. The selection module 128 returns to the 1031 module 124.

The 1031 module 124 is then continuously polling, at step 88, for a notification from the property owner 144 that the property has been sold. For example, the property owner 144 may send a notification to the 1031 module 124 that the property has been sold. In some aspects, the property owner 144 may have an account on the net lease network 102 and sign into the net lease network 102 to send the notification.

The 1031 module 124 receives, at step 814, a notification from the property owner 144 that the property has been sold. For example, the property owner 144 may send a notification to the 1031 module 124 that the property has been sold. In some aspects, the property owner 144 may have an account on the net lease network 102 and sign into the net lease network 102 to send the notification.

The 1031 module 124 initiates, at step 816, the escrow module 130. For example, the escrow module 130 begins by being initiated by the 1031 module 124. The escrow module 130 connects to the 3rd party financial institution 156. The escrow module 130 creates the escrow account. The escrow module 130 sends the property owner 144 the escrow account data. The escrow module 130 transfers the funds from the sale of the property into the escrow account. The escrow module 130 returns to the 1031 module 124.

The 1031 module 124 initiates, at step 818, the purchase module 132. For example, the purchase module 132 begins by being initiated by the 1031 module 124. The purchase module 136 extracts the property owner's 144 home data from the owner's database 120. The purchase module 136 extracts the purchase home data from the purchase database 136. The purchase module 126 compares the extracted data to the checklist database 138. The purchase module 126 determines if the purchase home meets the requirements to qualify for a 1031 exchange. If it is determined that the purchase home meets the requirements for a 1031 exchange, the purchase module 136 executes the 1031 exchange. If it is determined that the purchase home does not meet the requirements for a 1031 exchange, the purchase module 136 sends a notification to the property owner 144 that the purchase home does not meet the requirements for a 1031 exchange.

The purchase module 136 returns to the 1031 module 124. The 1031 module 124 returns, at step 820, the net lease module 104. In some aspects, the 1031 module 124 may return to sending a request to the property owner 144, that has just sold their property through the net lease network 102, to restart the 1031 exchange process for the property owner 144, that has just sold their property.

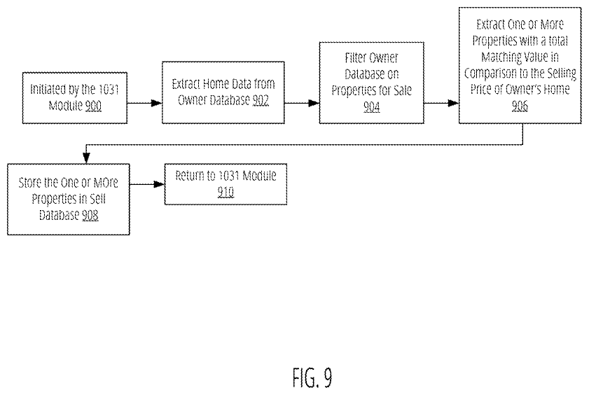

FIG. 9 illustrates an example method performed by an exchange module.

FIG. 9 displays the exchange module 126. The process begins with the exchange module 126 being initiated, at step 900, by the 1031 module 124. In some aspects, the exchange module 126 may be a standalone module continuously running in the background and may be initiated by receiving a notification from a property owner 144 to perform a 1031 exchange.

The exchange module 126 extracts, at step 902, the property owner's 144 home data from the owner database 120. For example, the exchange module 126 extracts the property data from the owner database 120, such as the owner's name, the owner ID, the property ID, the property address, the square footage, the number of bedrooms, the number of bathrooms, the original purchase price of the property, the sale price of the property or the price that the property has sold for, and the capital gain on the property or an estimate capital gain of the property if the property is sold at the property owner's 144 asking price.

The exchange module 126 filters, at step 904, the owner database 120 on properties for sale. For example, the exchange module 126 filters the owner database 120 on properties that other property owners 144 have listed for sale or indicated that they would be interested in selling. The exchange module 126 extracts, at step 906, properties in the owner database 120 that match the property owner's 144 selling price or price that the property owner 144 has sold their property. For example, the exchange module 126 extracts the properties for sale or, if the property owner has indicated they would be interested in selling, that match the original property owners 144 property. For example, if the original property owner 144 has sold or is selling their property for $1,000,000, then the exchange module 126 would extract the properties from the owner database 120 that have a listed sale price of $1,000,000 or if the property owner 144 has indicated that they are willing to sell and included an estimated sale price of the property.

In some cases, the exchange module 126 determines, based on the initial exchange amount, one or more bundles of the replacement properties of the identified replacement properties that have a total exchange amount considered to be within a threshold amount of the initial exchange amount. In other words, the selling property or the initial exchange amount may be $1,000,000 and the bundle of the replacement properties of the identified replacement properties amount may amount to at least $1,000,000 in total value.

In some cases, the exchange module 126 may use a machine-learning algorithm to output replacement properties that minimize a difference between the total exchange amount and the initial exchange amount for 1031 exchanges. In some cases, the machine-learning algorithm determines the weights based on training data including past selected bundled replacement properties.

In some aspects, the original property owner 144 or selling property owner 144 may include other data points of properties that they might be interested in purchasing to complete the 1031 exchange, such as a specific number of bedrooms, bathrooms, certain square footage, a specific price in the event they would like to find a cheaper property than they are selling the original property, certain features, amenities, views, etc.

The exchange module 126 stores, at step 908, the extracted properties from the owner database 120 that match the property owner's 144 selling price in the sell database 134. For example, the exchange module 126 stores the extracted properties for sale in the sell database 134, including the property ID, the address of the property, the square footage of the property, the number of bedrooms in the property, the number of bathrooms in the property, and the selling price of the property. In some aspects, the database may contain renovations to the property, any damages that have occurred on or in the property, such as fires, flooding, etc., other financial data related to the property, etc.

In some aspects, the database may contain various home data or property data, such as the type of location, for example, beachfront, beach access, water views, lakefront, etc., the type of property, such as a house, townhouse, apartment, condo, multi-family, etc., amenities within the property, etc. The exchange module 126 returns, at step 910, to the 1031 module 124.

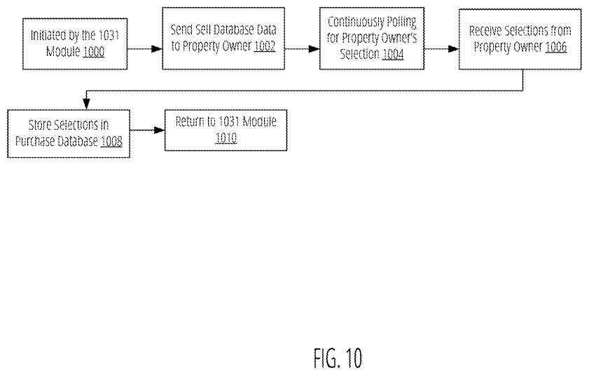

FIG. 10 illustrates an example method performed by a selection module.

FIG. 10 displays the selection module 128. The process begins with the selection module 128 being initiated, at step 1000, by the 1031 module. In some aspects, the selection module 126 may be a standalone module continuously running in the background and may be initiated once the sell database 134 is created.

The selection module 128 sends, at step 1002, the data in the sell database 134 to the property owner 144. For example, the selection module 128 sends the property owner 144 a list of properties for sale or properties that the property owner 144 has indicated an interest in selling for the property owner 144 to review and select properties of interest to satisfy the requirement of the 1031 exchange to designate a list of properties as replacement properties. The data may include the property ID, the address of the property, the square footage of the property, the number of bedrooms in the property, the number of bathrooms in the property, and the selling price of the property. In some aspects, the database may contain renovations to the property, any damages that have occurred on or in the property, such as fires, flooding, etc., other financial data related to the property, etc. In some aspects, the database may contain various home data or property data, such as the type of location, for example, beachfront, beach access, water views, lakefront, etc., the type of property, such as a house, townhouse, apartment, condo, multi-family, etc., amenities within the property, etc.

The selection module 128 is continuously polling, at step 1004, for the property owner's 144 selections. For example, the selection module 128 is continuously polling to receive the property owner's 144 selections from the sell database 134. For example, the selections may be a list of properties that the property owner 144 has an interest in purchasing as a swap property to satisfy a 1031 exchange.

The selection module 128 receives, at step 1006, the property owner's 144 selections from the sell database 134. For example, the selection module 128 receives the list of properties that the property owner 144 has an interest in purchasing. The selection module 128 may receive data from the property owner 144, such as the property ID, the address of the property, the square footage of the property, the number of bedrooms in the property, the number of bathrooms in the property, and the selling price of the property.

The selection module 128 stores, at step 1008, the property owner's 144 selections in the purchase database 136. For example, the selection module 128 stores the list of properties that the property owner 144 has an interest in purchasing in the purchase database 136. The data may include the property ID, the address of the property, the square footage of the property, the number of bedrooms in the property, the number of bathrooms in the property, and the selling price of the property.

In some aspects, the database may serve as the list of properties designated as replacement properties to satisfy the requirements of a 1031 exchange. The selection module 128 returns, at step 1010, to the 1031 module 124.

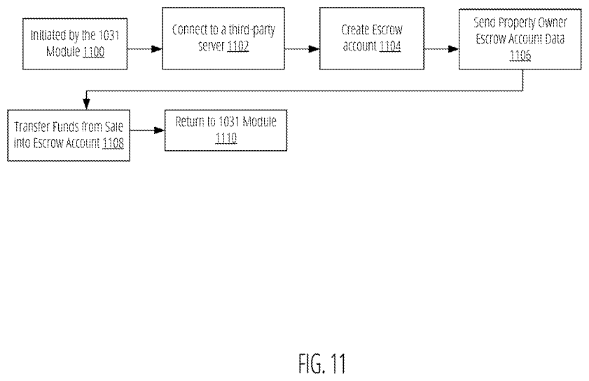

FIG. 11 illustrates an example method performed by an escrow module.

FIG. 11 displays the escrow module 130. The process begins with the escrow module 130 being initiated, at step 1100, by the 1031 module 124. In some aspects, the selection module 126 may be a standalone module continuously running in the background and may be initiated once the purchase database 136 is received from the property owner 144.

The escrow module 130 connects, at step 1102, to the 3rd party financial institution 156. For example, the escrow module 130 connects to the 3rd party financial institution 156 through the cloud 154. In some aspects, the net lease network 102 may act as the 3rd party financial institution 156 or as the intermediary to hold the funds of the sale of the property owner's 144 property.

The escrow module 130 creates, at step 1104, the escrow account. For example, the escrow module 130 creates an account to hold the funds from selling the property owner's 144 property. In some aspects, the net lease network 102 may have partnerships, agreements, etc., with a 3rd party financial institution 156 and with the property owner 144 to open up an escrow account for the property owner 144 using the 3rd party financial institution 156.

The escrow module 130 sends, at step 1106, the property owner 144 the escrow account data. For example, once the escrow account is created, the escrow module 130 may send the property owner 144 the account details to be used as the intermediary to hold the funds from the sale of the property. The escrow module 130 transfers, at step 1108, the funds from the sale of the property into the escrow account. For example, the escrow module 130 may transfer the funds from the sale of the property into the escrow account. In some aspects, the property owner 144 may transfer the funds.

In some aspects, the net lease network 102 may connect with the property owner 144, who is selling the property, to send the escrow account data so that the selling property owner 144 may transfer the funds into the escrow account and the property owner 144 purchasing the property may receive a notification from the escrow module 130 that the transaction has been completed. The escrow module 130 returns, at step 1110, to the 1031 module 124.

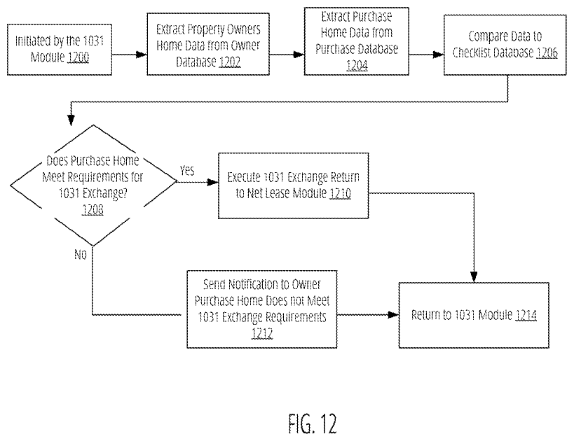

FIG. 12 illustrates an example purchase module.

FIG. 12 displays the purchase module 132. The process begins with the purchase module 136 being initiated, at step 1200, by the 1031 module 124. In some aspects, the selection module 126 may be a standalone module that is continuously running in the background and may be initiated once the funds from the sale of the property are transferred into the escrow account. The purchase module 136 extracts, at step 1202, the property owner's 144 home data from the owners database 120. For example, the purchase module 136 extracts the property owner's 144 property data or home data from the owners database 120, such as the owner's name, the owner ID, the property ID, the property address, the square footage, the number of bedrooms, the number of bathrooms, the original purchase price of the property, the sale price of the property or the price that the property has sold for, and the capital gain on the property or an estimate capital gain of the property if the property is sold at the property owner's 144 asking price.

The purchase module 136 extracts, at step 1204, the purchase home data from the purchase database 136. For example, the purchase module extracts the property data or home data that the property owner 144 has intentions of purchasing or has already purchased stored in the purchase database 136, such as the property ID, the address of the property, the square footage of the property, the number of bedrooms in the property, the number of bathrooms in the property, and the selling price of the property.

The purchase module 126 compares, at step 1206, the extracted data to the checklist database 138. For example, the purchase module 126 compares the extracted data from the owner database 120 and the purchase database 136 to the checklist database 138 to determine if the purchase of the new property would qualify for a 1031 exchange. For example, the purchase module 126 would compare the extracted to each requirement in the checklist database 138, and if the requirement is not satisfied, the purchase module 132 would extract the corresponding rule to see if the property owner 144 would qualify for the 1031 exchange. For example, the extracted data would include the property's location to be purchased or already purchased, and the checklist database 138 first requirement would be if the property is located in the United States. If so, the requirement is met or satisfied, and the data will be compared to the next requirement.

The purchase module 126 determines, at step 1208, if the purchase home meets the requirements to qualify for a 1031 exchange. For example, if the extracted data from the original property and the purchased property meet all of the requirements in the checklist database 138, the property owner 144 would qualify for the 1031 exchange. If not, the property owner 144 would not qualify for a 1031 exchange.

If it is determined that the purchase home meets the requirements for a 1031 exchange, the purchase module 136 executes, at step 1210, the 1031 exchange. For example, the purchase module 136 would use the data stored in the owner database 120 and the purchase database 136 to automatically fill out the 1031 exchange tax form, such as the description of the property given up, the description of the property received, the date the like-kind property was acquired, the date the property was transferred, etc. If it is determined that the purchase home does not meet the requirements for a 1031 exchange, the purchase module 136 sends, at step 1212, a notification to the property owner 144 that the purchase home does not meet the requirements for a 1031 exchange. The purchase module 136 returns, at step 1214, to the 1031 module 124.

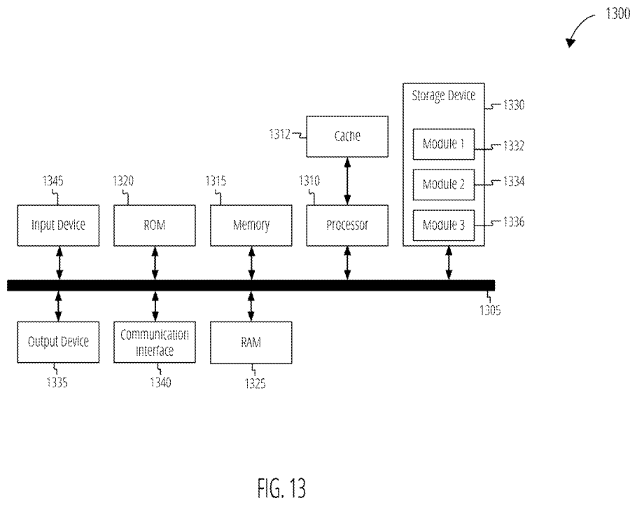

FIG. 13 shows an example system for implementing certain aspects of this disclosure of the present invention, which can be for example any computing device making up the net lease network 102 or the net lease system 100, or any component thereof in which the components of the system are in communication with each other using connection 2005. Connection 2005 can be a physical connection via a bus, or a direct connection into processor 2010, such as in a chipset architecture. Connection 2005 can also be a virtual connection, networked connection, or logical connection.

In some aspects, computing system 2000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 2000 includes at least one processing unit (CPU or processor) 2010 and connection 2005 that couples various system components including system memory 2015, such as read-only memory (ROM) 2020 and random access memory (RAM) 2025 to processor 2010. Computing system 2000 can include a cache of high-speed memory 2020 connected directly with, in close proximity to, or integrated as part of processor 2010.

Processor 2010 can include any general purpose processor and a hardware service or software service, such as services 2032, 2034, and 2036 stored in storage device 2030, configured to control processor 2010 as well as a special-purpose processor where software instructions are incorporated into the actual processor design. Processor 2010 may essentially be a completely self-contained computing system, containing multiple cores or processors, a bus, memory controller, cache, etc. A multi-core processor may be symmetric or asymmetric.

To enable user interaction, computing system 2000 includes an input device 2045, which can represent any number of input mechanisms, such as a microphone for speech, a touch-sensitive screen for gesture or graphical input, keyboard, mouse, motion input, speech, etc. Computing system 2000 can also include output device 2035, which can be one or more of a number of output mechanisms known to those of skill in the art. In some instances, multimodal systems can enable a user to provide multiple types of input/output to communicate with computing system 2000. Computing system 2000 can include communications interface 2040, which can generally govern and manage the user input and system output. There is no restriction on operating on any particular hardware arrangement, and therefore the basic features here may easily be substituted for improved hardware or firmware arrangements as they are developed.

Storage device 2030 can be a non-volatile memory device and can be a hard disk or other types of computer-readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 2030 can include software services, servers, services, etc., that when the code that defines such software is executed by the processor 2010, it causes the system to perform a function. In some aspects, a hardware service that performs a particular function can include the software component stored in a computer-readable medium in connection with the necessary hardware components, such as processor 2010, connection 2005, output device 2035, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some aspects, a service can be software that resides in memory of a client device and/or one or more servers of a content management system and perform one or more functions when a processor executes the software associated with the service. In some aspects, a service is a program or a collection of programs that carry out a specific function. In some aspects, a service can be considered a server. The memory can be a non-transitory computer-readable medium.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A computer-implemented method of automating a residential net lease management tool with a 1031 exchange module, comprising:
receiving, over an expense network, an initial exchange amount over a communication network at a net lease management server configured to communicate with at least one third-party application, wherein the initial exchange amount is associated with a property that is sold or on sale;
receiving, over the expense network, market data associated with one or more regions sent over the communication network at the net lease management server;
initiating, by a net lease module, a reserve module;
generating, by the reserve module, net lease parameters for the one or more regions based on a calculated profitability evaluation based on the market data received via the expense network, wherein the calculated profitability evaluation determines a threshold margin based on a percentage of an average rental rate and average fixed costs in the one or more regions;
initiating, by the net lease module, an owner module;
identifying, by the owner module, replacement properties that fall within the net lease parameters generated by the reserve module;
initiating, by the net lease module, an exchange module;
determining, by the exchange module and based on the initial exchange amount, one or more bundles of the replacement properties of the identified replacement properties that have a total exchange amount that is considered to have a value equal to or greater than the initial exchange amount;
initiating, by the net lease module, a manage module;
generating, by the reserve module, a set of net lease terms associated with the at least one of the replacement properties identified by the net lease module, based on inputs including fixed costs and variable costs determined the manage module, wherein weights are assigned to each input;
storing, by the net lease module in a lease database, the net lease terms;
recording, by an accounting module in a reserve database associated with a single reserve fund, a first accounting for a first amount funded by one or more investors that are not respective owners of the respective properties;
recording, by the accounting module in the reserve database associated with the single reserve fund, a second accounting for a second amount remunerated to the investors based on determined profit margins over term of lease and the net lease terms stored at the lease database; and
sending, based upon the accountings of the reserve database over the communication network, an instruction to trigger a transfer to the single reserve fund.

2. The computer-implemented method of claim 1, further comprising:
using a machine-learning algorithm to output the set of net lease terms, and wherein the machine-learning algorithm determines the weights based on training data including past net lease terms associated with the one or more regions.

3. The computer-implemented method of claim 1, further comprising:
using a machine-learning algorithm to output replacement properties that minimize a difference between the total exchange amount on the initial sale of property and the total exchange amount on the replacement property for like-kind property exchanges, and wherein the machine-learning algorithm determines the weights based on training data including past selected bundled replacement properties.

4. The computer-implemented method of claim 1, further comprising:
determining, by the manage module, the fixed costs and the variable costs based on data associated with at least one of the identified replacement properties and extracted data points from stored invoice data;
recording, by the accounting module in the reserve database associated with the single reserve fund, a third accounting for a third amount remunerated for the fixed costs based on the net lease terms stored at the lease database, wherein the fixed costs include at least one of property management, property taxes, property insurance, or property maintenance; and
recording, by the accounting module in the reserve database associated with the single reserve fund, a fourth accounting for a fourth amount remunerated to the respective owners for the identified replacement properties and collected from respective tenants per a rent schedule based on the net lease terms stored at the lease database.

5. The computer-implemented method of claim 1, wherein the market data includes at least one of starting market rent, market growth rate, inflation rate, vacancy rate, rent collectability rate, home price appreciation, operating expenses, local taxes, insurance rates, management fees, maintenance budget, homeowner's association fees, cost of utilities, or asset management fees.

6. The computer-implemented method of claim 1, wherein the inputs include at least one of average rent in the one or more regions, square footage of the respective property, market growth rate, inflation rate, vacancy rate, rent collectability rate, home price appreciation, or operating expenses.

7. The computer-implemented method of claim 1, further comprising:
sending a notification to the identified one or more owners regarding the one or more replacement properties; and
receiving an approval from one of the owners to generate a contractual agreement document associated with one of the replacement properties.

8. The computer-implemented method of claim 1, further comprising:
receiving market data associated with a different region sent over the communication network at the net lease management server;
generating a second set of net lease parameters for the different region based on the calculated profitability evaluation that determines the respective threshold margin;
identifying one or more second owners with one or more second replacement properties that fall within the second set of net lease parameters;
determining a second set of fixed costs and variable costs based on data associated with the one of the second replacement properties and extracted data points from stored invoices of associated vendors; and
generating a second set of net lease terms associated with the one of the second replacement properties based on the determined second set of fixed costs and variable costs, using a machine-learning algorithm that outputs the second set of net lease terms.

9. A system for automating a residential net lease management tool with an exchange module, comprising:
a storage configured to store instructions;
a net lease module that controls a reserve module, an owner module, an exchange module, a manage module, and an accounting module;
the reserve module that generates a plurality of net lease parameters for different regions;
the owner module that identifies replacement properties that fall within a particular net lease parameter;
the exchange module that identifies like-properties to the identified replacement properties for 1031 exchanges;
the manage module that determines fixed costs and variable costs;
the accounting module that records accountings; and
one or more processors configured to execute the instructions and cause the one or more processors to:
receive, over an expense network, an initial exchange amount over a communication network at a net lease management server configured to communicate with at least one third-party application;
receive, over the expense network, market data associated with one or more regions sent over the communication network at the net lease management server;
generate, by the reserve module, net lease parameters for the one or more regions based on a calculated profitability evaluation based on the market data received via the expense network, wherein the calculated profitability evaluation determines a threshold margin based on a percentage of an average rental rate and average fixed costs in the one or more regions;
identify, by the owner module, replacement properties that fall within the net lease parameters generated by the reserve module;
determine, by the exchange module and based on the initial exchange amount, one or more bundles of the replacement properties of the identified replacement properties that have a total exchange amount that is considered to have a value equal to or greater than the initial exchange amount;
generate, by the reserve module, a set of net lease terms associated with the at least one of the replacement properties identified by the net lease module, based on inputs including fixed costs and variable costs determined the manage module, wherein weights are assigned to each input;
store, by the net lease module in a lease database, the net lease terms;
record, by the accounting module in a reserve database associated with a single reserve fund, a first accounting for a first amount funded by one or more investors that are not respective owners of the respective properties;
record, by the accounting module in the reserve database associated with the single reserve fund, a second accounting for a second amount remunerated to the investors based on determined profit margins over term of lease and the net lease terms stored at the lease database; and
send, based upon the accountings of the reserve database over the communication network, an instruction to trigger a transfer to the single reserve fund.

10. The system of claim 9, wherein the processor is configured to execute the instructions and cause the one or more processors to:
use a machine-learning algorithm to output the set of net lease terms, and wherein the machine-learning algorithm determines the weights based on training data including past net lease terms associated with the one or more regions.

11. The system of claim 9, wherein the processor is configured to execute the instructions and cause the one or more processors to:
use a machine-learning algorithm to output replacement properties that minimize a difference between the total exchange amount the initial exchange amount for the replacement property under 1031 exchanges, and wherein the machine-learning algorithm determines the weights based on training data including past selected bundled properties.

12. The system of claim 9, wherein the processor is configured to execute the instructions and cause the one or more processors to:
determine, by the manage module, the fixed costs and the variable costs based on data associated with at least one of the identified replacement properties and extracted data points from stored invoice data;
record, by the accounting module in the reserve database associated with the single reserve fund, a third accounting for a third amount remunerated for the fixed costs based on the net lease terms stored at the lease database, wherein the fixed costs include at least one of property management, property taxes, property insurance, or property maintenance; and
record, by the accounting module in the reserve database associated with the single reserve fund, a fourth accounting for a fourth amount remunerated to the respective owners for the identified replacement properties and collected from respective tenants per a rent schedule based on the net lease terms stored at the lease database.

13. The system of claim 9, wherein the market data includes at least one of starting market rent, market growth rate, inflation rate, vacancy rate, rent collectability rate, home price appreciation, operating expenses, local taxes, insurance rates, management fees, maintenance budget, homeowner's association fees, cost of utilities, or asset management fees.

14. The system of claim 9, wherein the inputs include at least one of average rent in the one or more regions, square footage of the respective property, market growth rate, inflation rate, vacancy rate, rent collectability rate, home price appreciation, or operating expenses.

15. The system of claim 9, wherein the one or more processors is configured to execute the instructions and cause the one or more processors to:
send a notification to the identified one or more owners regarding the one or more properties; and
receive an approval from one of the owners to generate a contractual agreement document associated with one of the properties.

16. The system of claim 9, wherein the one or more processors is configured to execute the instructions and cause the one or more processors to:
receive market data associated with a different region sent over the communication network at the net lease management server;
generate a second set of net lease parameters for the different region based on the calculated profitability evaluation that determines the respective threshold margin;
identify one or more second owners with one or more second replacement properties that fall within the second set of net lease parameters;
determine a second set of fixed costs and variable costs based on data associated with the one of the second replacement properties and extracted data points from stored invoices of associated vendors; and
generate a second set of net lease terms associated with the one of the second replacement properties based on the determined second set of fixed costs and variable costs, use a machine-learning algorithm that outputs the second set of net lease terms.

17. A non-transitory computer readable medium comprising instructions, the instructions, when executed by a computing system, cause the computing system to:
receive, over an expense network, an initial exchange amount over a communication network at a net lease management server configured to communicate with at least one third-party application;
receive, over the expense network, market data associated with one or more regions sent over the communication network at the net lease management server;
initiate, by a net lease module, a reserve module;
generate, by the reserve module, net lease parameters for the one or more regions based on a calculated profitability evaluation based on the market data received via the expense network, wherein the calculated profitability evaluation determines a threshold margin based on a percentage of an average rental rate and average fixed costs in the one or more regions;
initiate, by the net lease module, an owner module;
identify, by the owner module, replacement properties that fall within the net lease parameters generated by the reserve module;
initiate, by the net lease module, an exchange module;
determine, by the exchange module and based on the initial exchange amount, one or more bundles of the replacement properties of the identified replacement properties that have a total exchange amount that is considered to have a value equal to or greater than the initial exchange amount;
initiate, by the net lease module, a manage module;
generate, by the reserve module, a set of net lease terms associated with the at least one of the replacement properties identified by the net lease module, based on inputs including fixed costs and variable costs determined the manage module, wherein weights are assigned to each input;
store, by the net lease module in a lease database, the net lease terms;
record, by an accounting module in a reserve database associated with a single reserve fund, a first accounting for a first amount funded by one or more investors that are not respective owners of the respective properties;
record, by the accounting module in the reserve database associated with the single reserve fund, a second accounting for a second amount remunerated to the investors based on determined profit margins over term of lease and the net lease terms stored at the lease database; and
send, based upon the accountings of the reserve database over the communication network, an instruction to trigger a transfer to the single reserve fund.

18. The computer readable medium of claim 17, wherein the computer readable medium further comprises instructions that, when executed by the computing system, cause the computing system to:
use a machine-learning algorithm to output the set of net lease terms, and wherein the machine-learning algorithm determines the weights based on training data including past net lease terms associated with the one or more regions.

19. The computer readable medium of claim 17, wherein the computer readable medium further comprises instructions that, when executed by the computing system, cause the computing system to:
use a machine-learning algorithm to output replacement properties that minimize a difference between the total exchange amount of the initial exchange and the total exchange amount of the replacement property for 1031 exchanges, and wherein the machine-learning algorithm determines the weights based on training data including past selected bundled replacement properties.

20. The computer readable medium of claim 17, wherein the computer readable medium further comprises instructions that, when executed by the computing system, cause the computing system to:
determine, by the manage module, the fixed costs and the variable costs based on data associated with at least one of the identified replacement properties and extracted data points from stored invoice data;
record, by the accounting module in the reserve database associated with the single reserve fund, a third accounting for a third amount remunerated for the fixed costs based on the net lease terms stored at the lease database, wherein the fixed costs include at least one of property management, property taxes, property insurance, or property maintenance; and
record, by the accounting module in the reserve database associated with the single reserve fund, a fourth accounting for a fourth amount remunerated to the respective owners for the identified replacement properties and collected from respective tenants per a rent schedule based on the net lease terms stored at the lease database.
